(19) United States
(12) Patent Application Publication
(10) Pub. No.: US 2017/0212274 A1
(43) Pub. Date: Jul. 27, 2017

(54) Borehole Acoustic Logging Receiver Quality Control and Calibration

(71) Applicant: Halliburton Energy Services, Inc., Houston, TX (US)

(72) Inventors: Baichun Sun, Perth (AU); Kristoffer T. Walker, Kingwood, TX (US); Philip W. Tracadas, Houston, TX (US); Wei Li, Singapore (SG); Ruijia Wang, Singapore (SG); Gary Kainer, Tomball, TX (US); Chung Chang, Houston, TX (US)

(73) Assignee: Halliburton Energy Services, Inc., Houston, TX (US)

(21) Appl. No.: 15/328,784

(22) PCT Filed: Aug. 18, 2016
(86) PCT No.: PCT/US2016/047568

§ 371 Date: Jan. 24, 2017

Related U.S. Application Data
(60) Provisional application No. 62/208,431, filed on Aug. 21, 2015.
(60) Provisional application No. 62/361,391, filed on Jul. 12, 2016.

(51) Int. Cl. G01V 13/00; G01V 1/48

(52) U.S. Cl. CPC G01V 13/00; G01V 1/48

(57) ABSTRACT

A method and system of performing quality control for a downhole tool. An acoustic source is employed to generate a Stoneley wave, and acoustic receivers generate signals indicative of the Stoneley wave. A reference value is calculated from the signals to assess the quality of the receivers. The reference value may be for a selected receiver or a selected receiver ring. The reference value is compared to a threshold deviation to determine if the reference value is outside the threshold deviation. If the reference value is outside of the threshold deviation, the deviation for one of the selected receiver or the selected receiver ring is corrected.

Acoustic logging operations are used to collect data regarding the rock formation around a borehole. Typically, an acoustic logging tool in the form of a wireline tool or logging while drilling tool is positioned within the borehole to collect such data. The acoustic logging tool emits one or more acoustic signals in multiple directions at the surrounding borehole wall or formation. The acoustic signal travels through the formation and returns to the logging tool having been altered by the formation. As different characteristics of the formation alter the signal differently, the returning signal carries data regarding characteristics and properties of the formation.

Quality control metrics for borehole acoustic logging receivers are useful for acoustic well logging because many of the measurements of the recorded signals are sensitive to assumptions about the receivers' acoustic amplitude and phase response. Such metrics generally serve four purposes: (1) provide a general understanding of the receivers' performance during acquisition, (2) provide a computational basis for the detection of slowly emerging problems with receiver sensitivity degradation over time, and (3) provide a basis for the detection of wiring or hardware problems due to the routine tool maintenance servicing as well as (4) provide accurate adjusting coefficients to balance receivers using signal processing operations. Detection of these issues can help reduce the downtime of the logging tool and maximize the quality of the recorded waveforms.

Certain metrics can also be used as “calibration” values or gains. When such gains are applied to the recorded waveforms, the imperfections in the receiver amplitude and phase response are corrected, which ultimately results in more accurate data products derived from the corrected waveforms.

### BRIEF DESCRIPTION OF THE DRAWINGS

For a detailed description of the embodiments of the invention, reference will now be made to the accompanying drawings in which:

FIG. 1 depicts an elevation view of a logging system with a logging tool suspended in a borehole, according to one or more embodiments;

FIG. 2 depicts a schematic view of an example transmitter-receiver configuration and transmitter-receiver ring geometry, according to one or more embodiments;

FIG. 3 depicts a graph view of filtered signals indicative of a Stoneley wave, according to one or more embodiments;

FIG. 4 depicts a graph view of filtered and azimuthally averaged signals, according to one or more embodiments;

FIGS. 5A and B depicts graph views of impulse and amplitude responses of a finite impulse response filter, according to one or more embodiments;

FIG. 6 depicts a graph view of an example Stoneley wave signal and the Stoneley wave signal's corresponding instantaneous amplitude, according to one or more embodiments;

FIG. 7 depicts a flow chart of a method to determine a phase variation of a receiver, according to one or more embodiments;

FIG. 8 depicts a graph view of Stoneley wave signals and measured arrival times, according to one or more embodiments;

FIG. 9 depicts a graph of a decomposed signal from the Stoneley signals of FIG. 8, according to one or more embodiments;

FIG. 10 depicts a graph view of normalized phase variations calculated from multiple depth measurements, according to one or more embodiments;

FIG. 11 depicts a graph view of phase variations that are normalized based on a sampling rate, according to one or more embodiments;

FIG. 12 depicts a graph view of phase variations for modally decomposed signals, according to one or more embodiments;

FIG. 13 depicts a flow chart of a method to determine a phase variation for a ring of receivers, according to one or more embodiments; and

FIG. 14 depicts a graph view of ring phase variations, according to one or more embodiments;

FIG. 15 depicts a flow chart of a receiver sensitivity quality control process, according to one or more embodiments, according to one or more embodiments;

FIG. 16A depicts graph view of Stoneley wave signals including a signal generated by receiver with a crossed polarity, according to one or more embodiments;

FIG. 16B depicts a graph view of a reference signal calculated to analyze the polarity of a receiver, according to one or more embodiments;

FIG. 17 depicts a graph view of arrival time variations for receivers, according to one or more embodiments;

FIG. 18 depicts a graph view of the phase corrected signals of FIG. 3, according to one or more embodiments;

FIG. 19 depicts a graph view of residual percentage variations of the ring magnitude for a depth of acquisition, according to one or more embodiments;

FIG. 20 depicts a graph view of receiver amplitude sensitivities calculated for a depth of acquisition, according to one or more embodiments;

FIG. 21 depicts graph views of histograms of instantaneous amplitudes for the receivers in a ring across multiple measurements in a cased borehole, according to one or more embodiments;

FIG. 22 depicts a graph view of the phase and amplitude corrected signals of FIG. 3, according to one or more embodiments;

FIG. 23 depicts a graph view of a histogram of receiver amplitude gain factor distribution for multiple measurements, according to one or more embodiments;

FIG. 24 depicts a graph view of a log of receiver amplitude percentage variations of a ring of receivers, according to one or more embodiments;

FIG. 25 depicts a graph view of amplitude sensitivity variations for the receivers across multiple depth measurements, according to one or more embodiments;

FIG. 26 depicts a graph view of ring amplitude variations calculated from multiple depth measurements, according to one or more embodiments;

FIG. 27 depicts a graph view of gains computed from the receiver amplitude variations of FIG. 25, according to one or more embodiments;

FIG. 28 depicts a graph view of gains computed from the ring amplitude variations from FIG. 26, according to one or more embodiments;

FIG. 29 depicts a graph view of the gain corrections of FIG. 27 applied to the amplitude variations, according to one or more embodiments;

FIG. 30 depicts a graph view of amplitude variations for receivers using modally decomposed signals, according to one or more embodiments;

FIG. 31 depicts a graph view of gain corrections applied to the signals before dipole decomposition, according to one or more embodiments;

FIGS. 32A and B show graph views of residual signals and recorded signals to assess the amplitude variations of the signals, according to one or more embodiments;

FIG. 33A shows a chart view of ratios of Stoneley wave signals and the residuals converted to decibel values, according to one or more embodiments;

FIG. 33B shows a graph view of the decibel values of FIG. 33A, according to one or more embodiments; and

FIGS. 34A and B show graph views of a log-based quality control display for the residual Stoneley waves, according to one or more embodiments.

### DETAILED DESCRIPTION

This proposed invention provides an algorithm and work flow for providing acoustic receiver metrics and calibration factors that may be run in real-time or in post-processing. Receiver-recorded Stoneley waves have unique characteristics that make them useful as a quality control and calibration tool. The Stoneley wave responses are compared to a statistical reference calculated from the receiver recordings. The differences from the reference are used to derive variations in the receiver sensitivity, which may be monitored against a threshold to indicate when a receiver has deteriorated in its performance. Maintaining high quality receivers benefits the resulting signal analyses and leads to more accurate formation evaluation results, such as dispersion analysis, anisotropy analysis, etc.

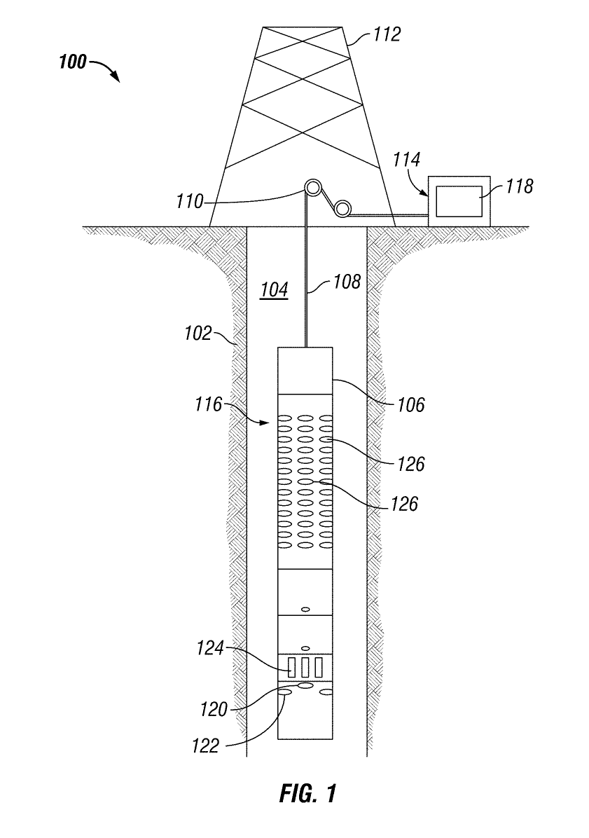

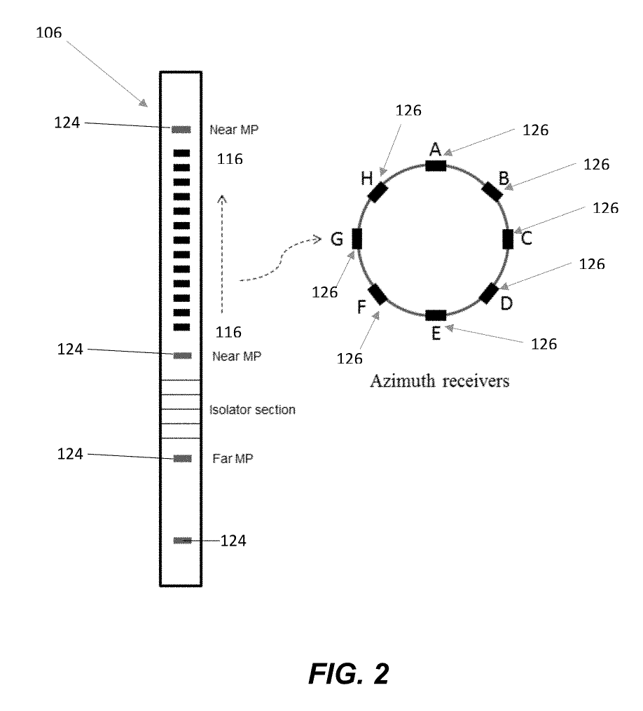

Referring to the drawings, FIG. 1 depicts an elevation view of a logging system 100 with a downhole logging tool 106 suspended in a borehole 104, in accordance with one or more embodiments. The borehole 104 is formed in a subsurface formation 102. The logging tool 106 is suspended from a wireline cable 108 and may have optional centralizers (not shown). The wireline cable 108 extends from the borehole over a sheave wheel 110 on a derrick 112 to a winch forming part of surface equipment 114. The tool 106 may include any of many means for detecting and indicating tool orientation, such as magnetometers. The tool 106 also includes one or more types of sensors for detecting well conditions. The tool 106 further includes processing and interfacing circuitry operable to sample, amplify, and digitize the data received from the sensors for transmission to the surface equipment 114 via the cable 108. The surface equipment 114 is configured to generate and/or provide electrical power and control signals for coordinating operation of the tool 106. The electrical power and/or control signals may be communicated via the cable 108 to circuitry provided within the tool 106. The logging tool 106 may be a wireline logging device as illustrated in FIG. 2. The logging tool 106 may also be any other type of suitable logging device, including a logging while drilling (LWD) or measurement while drilling (MWD) device used with a borehole drilling system instead of a wireline or cable 108. It should be appreciated that the logging tool 106 may be positioned in the borehole 104 using any suitable conveyance, such as slickline, coiled tubing, wireline cable, drill pipe, work string, or a downhole tractor.

In one or more embodiments, the logging tool 106 may include one or more multi-pole transmitters (e.g., dipole transmitters) 120, 122 and a low frequency monopole transmitter 124, capable of exciting and emitting compressional, shear, Stoneley, and flexural waves. The logging tool 106 also includes a plurality of receivers 126 arranged on the logging tool spaced from the transmitters 126 and configured to receive waves from the borehole as data. The receivers 126 may include one or more transducer-based devices such as hydrophones. In one or more embodiments, the receivers 126 are mounted around the circumference of the tool 106 at regular intervals, or rings 116. One or more embodiments of the receiver quality control and calibration method may be performed on the logging tool 106 shown in more detail in FIG. 2. The logging tool 106 includes at least one receiver ring 116, with each ring 116 including at least one receiver 126. In the example depicted in FIG. 1, the tool 106 includes 13 receiver rings 116 spaced at 0.5 feet (0.1524 m) apart, with each ring 116 including eight azimuthally spaced receivers 126 for a total of 104 receivers to be monitored for quality assessment. Within the tool 106 there are different types of transmitters (vibration sources).

The surface equipment 114 collects measurements from the tool 106, and includes a computer system 118 for processing and storing the measurements gathered by the sensors and receivers 126. Among other things, the computer system 118 may include a processor and a non-transitory machine-readable medium (e.g., ROM, EPROM, EEPROM, flash memory, RAM, a hard drive, a solid state disk, an optical disk, or a combination thereof) capable of executing instructions to perform such tasks. The surface equipment 114 may further include a user interface (not shown), e.g., a monitor or printer, to display the measurements and quality control graphics, as further described herein. In addition to collecting and processing measurements, the computer system 118 may be capable of controlling the logging tool 106.

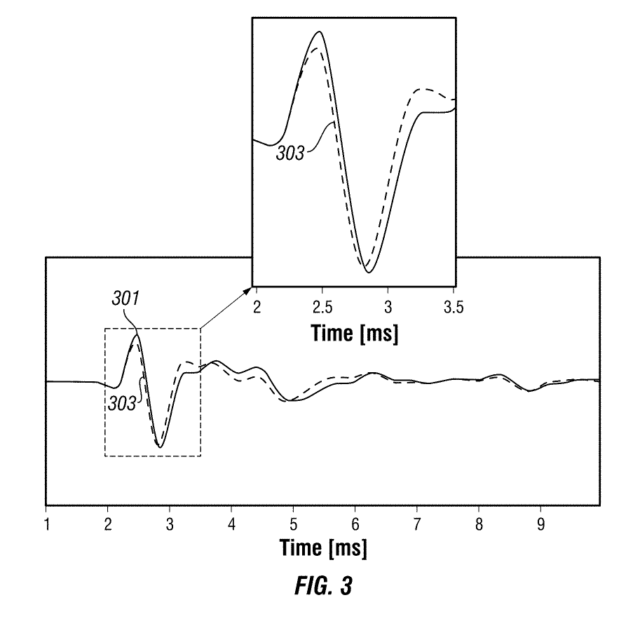

To monitor the sensitivities of the receivers 126, a low frequency monopole source (MPLF) 124 generates a Stoneley wave. The receivers 126 are operable to generate a signal indicative of the Stonely wave propagating through the borehole. The Stoneley wave produced may also be band-pass filtered to result in a wave in the desired frequency range, an example of which is shown in FIG. 3. The Stoneley wave at such low frequencies generally provides a signal that has a uniform particle motion at the receiver ring level regardless of distance from the borehole wall. This permits isolation of the receiver's amplitude and phase response from effects due to non-centralization of the receivers 126 in the chamber or borehole irregularities next to the receivers 126. This allows for overcoming challenges associated with leaks in which the internal fluid has vacated the receiver body, which causes a low-frequency sensitivity roll-off and phase shift of the receivers' response. However, the logging tool 106 may be centered in a cased section of the borehole 104 where the Stoneley wave measurements provide improved sensitivity references.

FIG. 3 shows a graph view of an example of filtered signals 301 indicative of a Stoneley wave. As shown, eight band-pass filtered signals 301 are overlaid on each other in the graph. The signals 301 are almost identical except the signal 303 for receiver F (dashed line, also shown in the magnified window), which is mismatched with the rest of the receivers. As described in more detail below, a signal generated from a receiver can be compared with the signals from multiple receivers in the same ring to identify and correct data recorded from the receiver ring and/or an individual receiver, such as receiver F.

If any one of the receivers has a sensitivity that is significantly different than the others, this imbalance can affect the decomposition results and ultimately alter the results of the subsequent data products. For example, acoustic characterization of stress, lithology, fracture conductivity, and permeability are all affected by the quality of the decomposed waveforms. Tools can have a quantified engineered receiver sensitivity tolerance, such as 5%, which can be used by the proposed method to detect problematic receivers for future hardware replacements. Regardless if a receiver is flagged as problematic, provided that the problem is not too severe, the correction factor calculated by one or more embodiments described herein can be used to ameliorate the condition.

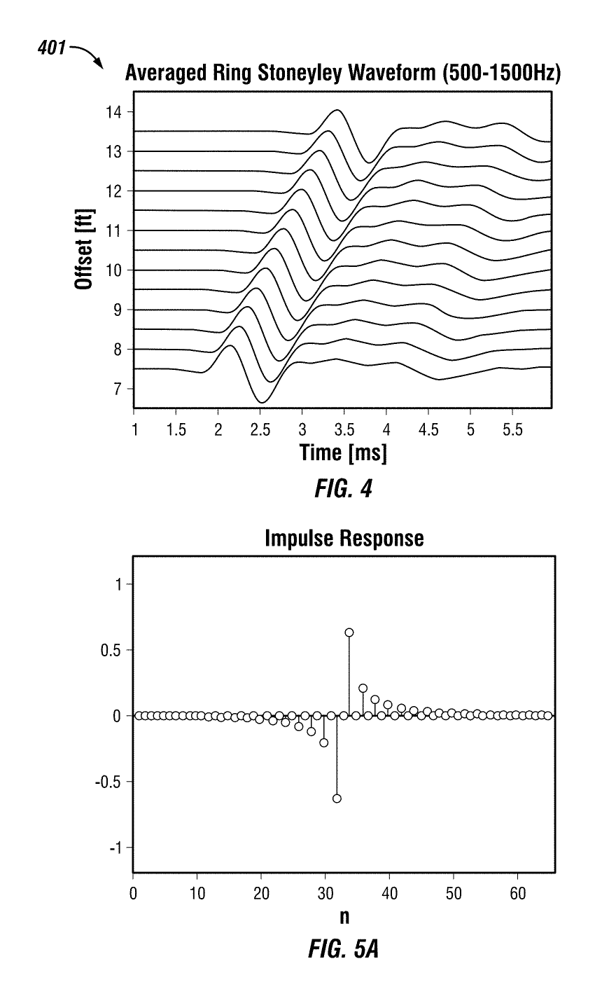

Some tools have hardware configurations that effectively permit receiver rings to have their own sensitivity factor that is independent from the sensitivity factors of the individual receivers. FIG. 4 shows a graph view of signals 401 of a Stoneley wave recorded by a ring of receivers, in accordance with one or more embodiments. As shown, each signal 401 is a filtered and azimuthally averaged result from receivers in a ring. The signals 401 are consistent, and amplitude attenuations are small with offset. This general Stoneley wave characteristic is used as a measure to predict ring sensitivity variations with offset, and thus, by comparing the measured and the predicted ring waveform amplitudes based on a threshold deviation, the ring sensitivities can be obtained.

Modally decomposed signals may be analyzed to identify deviations in the decomposed signal and implement corrections for modal decomposition operations, such as processing bi-modally decomposed signals. As used herein, modal decomposition refers to a mathematical transformation of a wave field into the wave field's circular harmonic modal components. For example, assuming a circular borehole environment with a centered tool, the decomposition depends on the firing type using weighted combinations of the different receivers Rᵢⱼₖ, where i is source type (0=monopole, 1=dipole), j is the ring number (1 to 13), and k is the receiver number within the ring (1 to 8). For the monopole decomposition, such as that used to optimally measure the borehole Stoneley wave response, an average of all receivers in each ring is required

$$( \frac{1}{2} {\sum }_{k = 1}^{N} {R}_{0 jk} ) .$$

One implementation for the dipole decomposition is taking the difference of each pair receiver with its 180 degree counterpart, such as that used to measure the borehole flexural wave response, one receiver is averaged with its negated 180 degree counterpart, such as (R₁ⱼ₁-R₁ⱼ₅)/2 and (R₁ⱼ₃-R₁ⱼ₇)/2.

### Receiver Sensitivity Characterizations

The receiver amplitude sensitivities are assumed to be characterized by a single constant value (across all frequencies) derived from making some measurement of the recorded Stoneley wave amplitude. The amplitude may be measured by any suitable method to characterize the amplitude, including root-mean-square (RMS) amplitude of the Stoneley wave and Maximum Magnitude of Analytical Signal (MMAS).

RMS amplitude

The Stoneley wave RMS amplitude is defined as the square root of the arithmetic mean of the squares of the waveform function,

$${x}_{rms} = \sqrt{\frac{1}{n} ( {x}_{1}^{2} + {x}_{2}^{2} + ⋯ + {x}_{n}^{2} ) ,}$$

where xᵢ denotes the amplitude of the waveform at sample i and n denotes the window length in samples. The RMS value represents the effective amplitude of the Stoneley waveform. It is a stable measurement using multiple data points. A correctly windowed waveform can improve the accuracy of the RMS measurement, but, due to waveform distortion and attenuation during the propagation, the choice of the time window position and size will influence the RMS value.

### Maximum Magnitude of Analytical Signal (MMAS)

Maximum magnitude of analytical signal (also called maximum instantaneous amplitude) is another measurement proposed for receiver sensitivity characterization. The maximum magnitude of the analytical signal is defined as absolute amplitude of an analytical signal, which has no negative-frequency component and can be represented as,

$$z ( t ) = \frac{1}{π} {\int }_{0}^{∞} Z ( ω ) {e}^{j ω t} d ω ,$$

where Z(ω) is Fourier transform of a real signal x(t) and is followed by complex coefficients of positive-frequency complex sinusoid e^{jωt} at frequency ω, which then integrated over frequency sets the analytical signal amplitudes and phases. For a complicated real signal x(t) in time domain, z(t) is a complex number and can be represented as,

z(t)=x(t)+jy(t),

where x(t) is a real signal and the imaginary part y(t) is a 90-degree phase shift from the real component, which contributes to avoid a negative-frequency component.

In general, there are two methods of obtaining an analytical signal of a real function. The first method is by performing Hilbert transform in frequency domain, which can be given as,

z(t)=F⁻¹(Z(ω)·(−j·sgn(ω))),

where F⁻¹ represents inverse Fourier transform. The sgn(ω) is a sign function given as,

$$sgn ( ω ) = \{ \begin{matrix}1 , & ω > 0 \\ 0 , & ω = 0 \\ - 1 , & ω < 0\end{matrix} ,$$

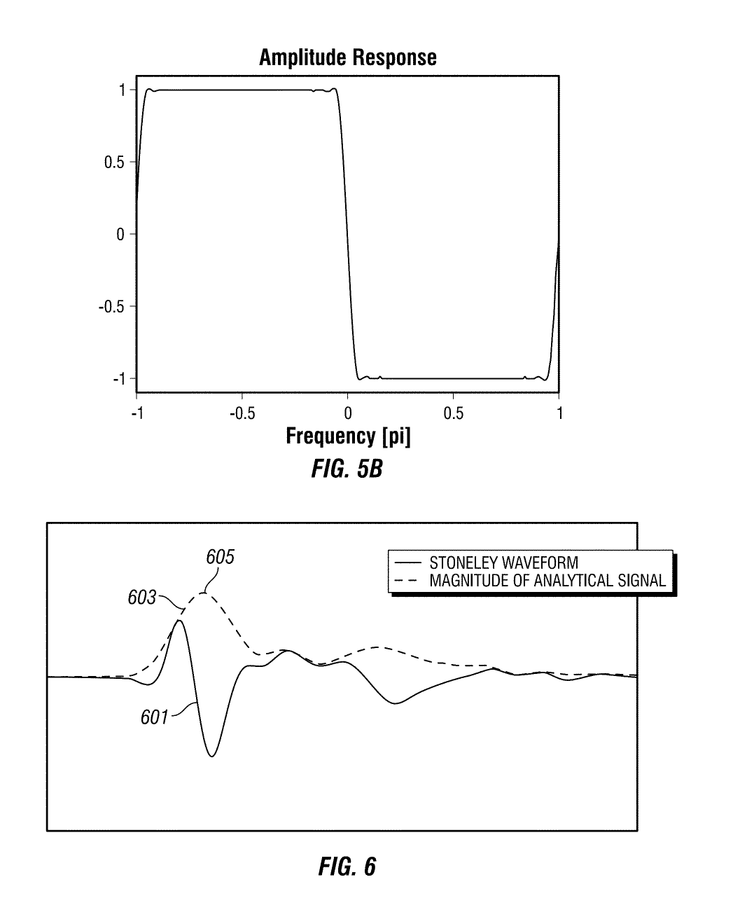

Another method of obtaining an analytical signal is to derive a 90-degree phase shifted component in the time domain using a finite impulse response (FIR) filter. The sign function of the frequency domain provides a desired amplitude response of the filter. By inverse transform the response, the desired FIR filter coefficients can be obtained. FIGS. 5A and B show graph views of a 65-point filter and the filter's amplitude response, respectively, in accordance with one or more embodiments. A Hanning window is applied to the impulse response. The FIR filter's impulse response is antisymmetric with odd number of impulse length. The FIR filter's impulse response can be given as,

$$h ( t ) = \{ \begin{matrix}\frac{2}{π} & \frac{{sin}^{2} π ( t - α ) / 2}{t - α} , t \neq α \\ & 0 , t = α\end{matrix} ,$$

where α=(M-1)/2 and M is the length of impulse response. Note the impulse response is set to zero when there is a singular at t=α. The 90-degree phase-shifted imaginary part can be expressed as a convolution,

y(t)=x(t)*h(t).

The analytical signal amplitude magnitude of z(t) is thus defined as \sqrt{x²+y²}. Even if the signals being analyzed are dispersive, the MMAS is a stable method of measuring peak amplitudes as a function of source-receiver offset.

FIG. 6 depicts a graph view of an example Stoneley wave signal 601 and the signal's corresponding amplitude magnitude 603, in accordance with one or more embodiments. As shown, the magnitude 603 of the signal is positive and includes a local maxima 605. Additionally, the use of maximum instantaneous amplitude (MMAS) as the receiver sensitivity measurement eliminates the need of a moving window, which can sometimes cause problems in practice that requires a fine tuning parameter.

### Receiver Sensitivity Quality Control Metrics

The amplitude of the Stoneley wave naturally decays exponentially away from the source. The exact rate of decay depends on many things including but not limited to the frequency, formation permeability, and borehole diameter. Therefore, it is helpful to characterize the receivers inside casing where the borehole is isolated from the formation. This is particularly important for a slow formation borehole.

In order to find receiver or ring outliers with inconsistent sensitivities, such as deviations in amplitude or phase, a reference value for a receiver or a ring may be calculated using the recorded signals and compared to a threshold deviation. Calculating the reference value may comprise at least one of identifying an arrival time of the Stoneley wave, determining a maximum instantaneous amplitude of the signal, determining a root-mean-square amplitude of the signal, and modally decomposing the signal, as described in further detail below. The reference value for a receiver may be relative to a median parameter of the signals generated from the receivers in a ring, such as a median amplitude or median arrival time. The reference value for a receiver may comprise, but is not limited to, a percent variation of a residual value of a parameter of signal generated by a selected receiver (e.g., instantaneous amplitude of the signal from the selected receiver) and a median parameter of the signals from a receiver ring (e.g., the median amplitudes and/or arrival times of the receivers in the receiver ring). In determining the reference value for the selected receiver, the parameter of a signal generated by the selected receiver may include at least one of an arrival time of the Stoneley wave for the selected receiver to determine a phase variation, a maximum instantaneous amplitude of the signal for the selected receiver, and a root-mean-square amplitude of the signal for the selected receiver, as further described herein. The reference value for a receiver ring may comprise a percent variation of a residual value of a median parameter of a selected receiver ring and a predicted receiver ring sensitivity, which may be based on, for example, the exponential decay of Stoneley wave for an amplitude variation or travel time and acoustic velocity for a phase variation.

For example, the median of the sensitivities (RMS amplitude or MMAS) of the signals (e.g., all eight depicted in FIG. 2) generated from the receivers in a ring is used to provide a median amplitude ring sensitivity. Aᵢⱼ may be used to denote a measured receiver ij Stoneley wave amplitude sensitivity, where i denotes ring number (i=1, 2, . . . n) and j denotes receiver azimuth number (j=1, 2, . . . m). The median amplitude ring sensitivity (AR) is given as,

ARᵢ=median {Aᵢⱼ, j=1, 2 . . . m.

The sensitivity percentage variation (dA) of each receiver with respect to the median ring sensitivity can be calculated and provides a reference value that is compared with a threshold deviation to determine any receivers that exhibit amplitude issues. The amplitude sensitivity percentage variation (dA) is given as:

$${dA}_{ij} = \frac{\vert {A}_{ij} - {AR}_{i} \vert}{{AR}_{i}} \times 100 ,$$

A 5% variation from the median is set as a threshold deviation, which includes a range relative to a median parameter, such as the median amplitude sensitivity (AR). If any receiver has variations outside the threshold deviation, the receiver may reduce the wave modal purity of a decomposed wave, and thus, the receiver may be flagged for correcting the amplitude deviation. As non-limiting examples, correcting a deviation may include at least one of physically inspecting the receiver, repairing the receiver, replacing the receiver, calibrating the receiver, and adjusting the signals generated by the receiver as further described herein. As used herein, calibration refers to establishing one or more correction factors that may be used to correct logs or data collected with a receiver and/or receiver ring. It should be appreciated that any other suitable threshold deviation may be selected to analyze the sensitivity of the receiver.

The median amplitude ring sensitivity (AR) can also be used to assess the quality control for a receiver ring. Based on exponential decay of Stoneley wave with offset, a predicted amplitude ring sensitivity [symbol] can be estimated. The ring sensitivities can be evaluated based on a reference value for a selected receiver ring using a percentage variation (dAR) of the residuals of measured and predicted ring sensitivities given by:

$$dAR = \frac{\vert - {AR}_{i} \vert}{} \times 100$$

A 10% variation of the residuals to the predicted median is set as a threshold deviation to identify rings for further investigation, such as an issue related to the ring electronics. Other suitable threshold deviations may be selected to analyze the sensitivity of the ring. If any ring has a reference value outside the threshold deviation, the ring may be flagged for correcting the amplitude deviation, such as physically inspecting the ring, repairing the ring, replacing the ring or components of the ring, calibrating the ring, and/or adjusting the signals generated by the ring as further described herein.

To provide a metric of quality control for phase variations produced by receivers, a Stoneley wave arrival time for the receiver can be determined from the signal and denoted as tᵢ, where i represents the receiver azimuth number. To improve the accuracy of identifying the arrival time tᵢ, a linear interpolation method may be applied using three or more points around the MMAS, or any other suitable representation of a peak amplitude, such as RMS amplitude. A arrival time variation is defined as,

$${τ}_{i} = \frac{{t}_{i} - \tilde{t}}{{σ}_{ave}} , i = 1 , 2 … m ,$$

where t denotes median arrival time for the receivers of a ring, and σₐᵥₑ denotes the averaged deviation, which is derived from measured percentiles. The arrival time variation, πᵢ, can be used as a reference value for a selected receiver to assess the phase sensitivity of the selected receiver relative to a threshold deviation. The averaged deviation, σₐᵥₑ, can defined as:

$${σ}_{ave} = \frac{{P}_{1} - {P}_{2}}{2} ,$$

where Pⱼ(j=1, 2) is the percentile of the vector tᵢ and represents an averaged distance to the median of tᵢ. For example if P₁ is 85% and P₂ is 15% percentile of the arrival time vector, the averaged deviation, σₐᵥₑ, is an averaged 35% deviation to the median of the vector. A threshold deviation for arrival time variation πᵢ is set as above 3 or below −3. Other sutiable thresholds may be selected based on the level of quality control desired. If any receiver has a reference value outside the threshold deviation, the receiver may be flagged for correcting the phase deviation, such as physically inspecting the receiver, repairing the receiver, replacing the receiver, calibrating the receiver, and/or adjusting the signals generated by the receiver as further described herein.

An anomalous variation in the phase response of a receiver can also result in an error in the use of that receiver in the decomposition of waveforms (in particular for dipole decomposition) or in other data products. To avoid this error, a metric of quality control of the receiver phase may be determined. Instead of displaying the relative and absolute arrival time variations of a receiver with respect to other receivers within a ring, the ratio of arrival time variations can be normalized with a period of a frequency of interest, such as a dominant frequency in the recorded signal or other suitable frequency. The normalized arrival time variation is useful to help determine the amount of degradation of a semblance slowness result, e.g., when the period of the semblance drive pulse matches that used in the signal analyzed for quality control of the phase. The normalized arrival time variation can be used as a reference value to assess the phase error of a receiver and/or ring based on a threshold deviation as discussed in further detail below.

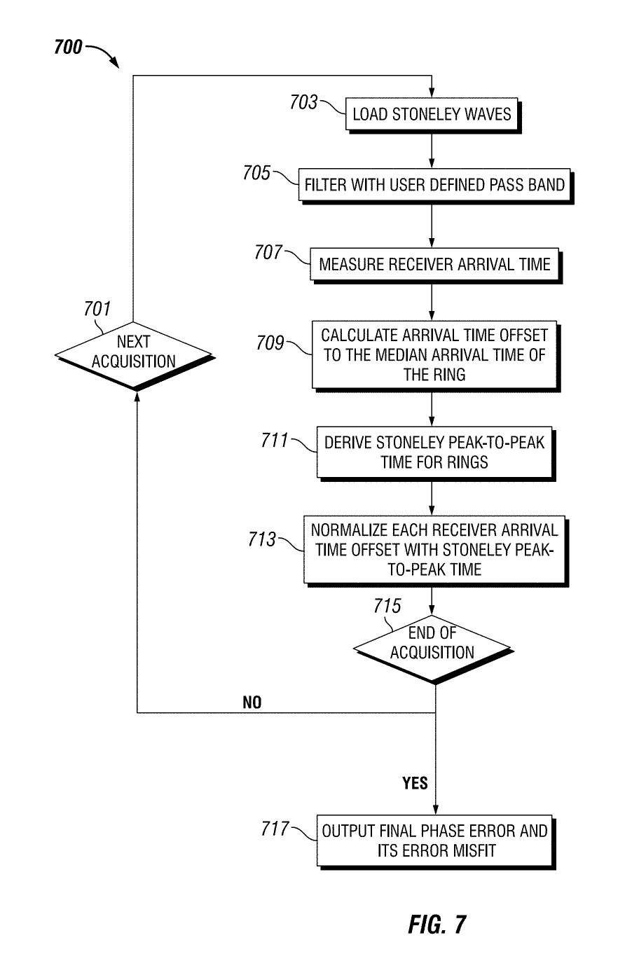

FIG. 7 shows a flow chart view of a method 700 to determine a phase variation of a signal generated by a receiver, in accordance with one or more embodiments. As shown, acoustic wave data is acquired using an acoustic logging tool at step 701 and stored on a computer at step 703. The raw Stoneley wave data acquired from the field acoustic logging are generally stored on a computer that may include a processor or processors such as a central processing unit (CPU) and local memory disposed in the logging tool 106. The processor may be operable to perform the steps of the method 700 and other methods as described herein. The computer may further include a permanent memory (e.g., a hard disk), and a random access memory (RAM). The memory may include a program that includes instructions for performing the methods of the embodiments, which may be performed by the processor, the permanent memory, and/or the RAM. A program may be embodied on any computer retrievable medium, such as ROM, EPROM, EEPROM, flash memory, RAM, a hard drive, a solid state disk, an optical disk, or any other medium known or yet to be developed. The programming may be accomplished with any programming language and the instructions may be in a form of a source code that may need compilation before the computer can execute the instructions or in a compiled (binary) or semi-compiled codes. The precise form and medium of the program is not germane to the embodiments and does not limit the scope of the invention. At step 705, the Stoneley wave signals are filtered using a band-pass filter (e.g., 0.5 to 1.5 kHz band-pass filter) or any other suitable filter.

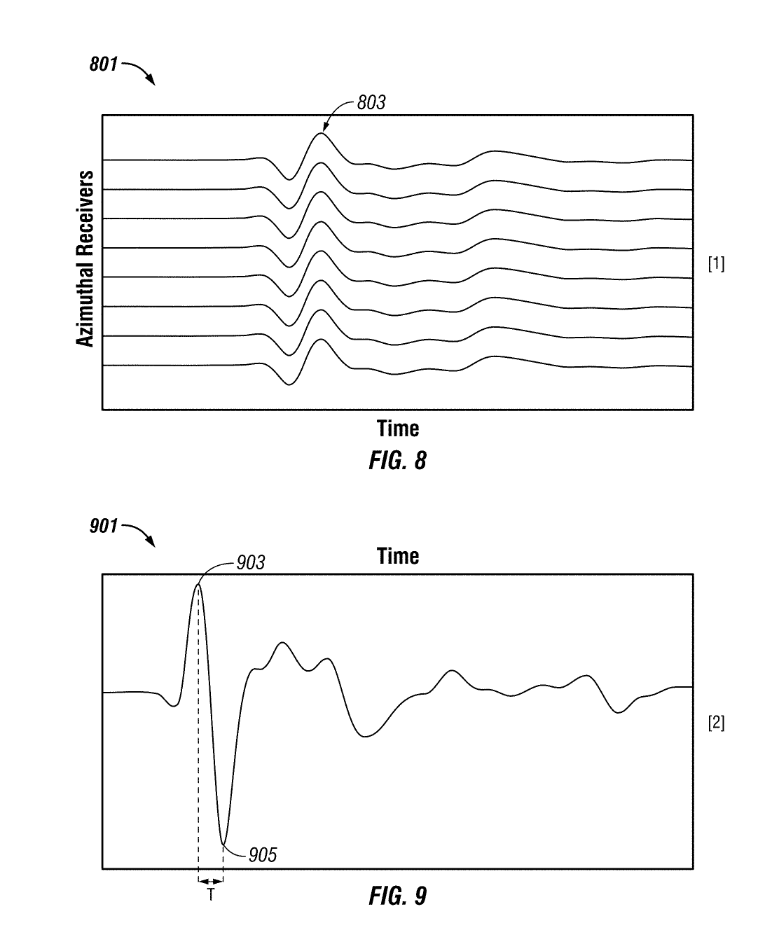

Stoneley waves phase variations can be calculated after the band pass filter operation of the recorded signals. The filtering procedure generates modally purer Stoneley waves to prevent the interference from any other unwanted wave modes or non-ideal conditions. At step 707, the arrival time (tᵢ) for each receiver within a single ring is measured by using various suitable methods, such as first break, maximum amplitude, zero crossing point, etc. For example, FIG. 8 shows a graph view of recorded Stoneley waves 801 with measured arrival times at the absolute amplitudes 803, in accordance with one or more embodiments. In this process, a decomposed signal can be used to ensure the arrival time trackings are all in the same corresponding waveforms for all receivers in a ring.

Referring to FIG. 7, in order to gain high accuracy of the arrival time, interpolation is needed during the process of arrival time identification. Time-delay differences among receivers within the same ring can be obtained by subtracting the median arrival time (\tilde{t}) at step 709. A normalization factor (T) is determined based on a period of a frequency of interest used to analyze the phase error at step 711. For example, FIG. 9 shows graph view of a decomposed signal 901 of the eight receiver waveforms of FIG. 8, in accordance with one or more embodiments. As shown in FIG. 9, a Stoneley wave peak-to-peak time duration (T) is measured between two dominant peaks 903 and 905. The peak-to-peak time duration (T) depicted in FIG. 9 represents a time duration from a local maxima 703 to a local minima 705 used to estimate half the period of a dominant frequency in the recorded Stoneley waves 801 of FIG. 8. The peak-to-peak time duration (T) can also be estimated from zero-crossing points on both sides of the dominant frequency's maximum amplitude. Referring to FIG. 7, at step 713, the normalization factor (T) is used to normalize the residual arrival time for each receiver in a ring given by:

$${τ}_{i} = \frac{{t}_{i} - \tilde{t}}{T} , \\ i = 1 , 2 … 8$$

where πᵢ represents the normalized residual arrival time for each receiver, which may be used as a reference value for a selected receiver. Thus, the reference value for the selected receiver may include a normalized residual value of an arrival time for the selected receiver and a median arrival time for a receiver ring.

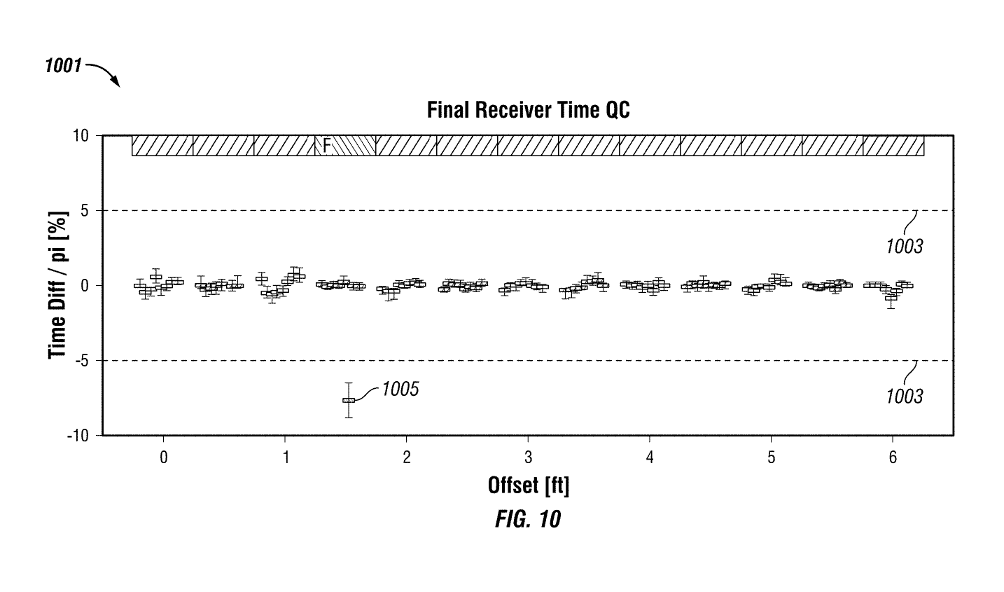

The phase variations for receivers can continue to be determined for other recorded signals at step 701 if the other signals are available for processing at step 715. Otherwise, the phase variations can be output at step 717. For example, FIG. 10 shows a graph view of the normalized receiver phase variations 1001 derived from measurements at multiple acquisition depths, in accordance with one or more embodiments. As shown, a threshold deviation 1003 of 5% is selected to determine receivers with phase issues. However, the threshold deviation 1003 is arbitrary and a nonlinear function if the threshold deviation 1003 is linked to the frequency range used by the data products of interest. Most of the receiver phase variations 1001 are below 2%, but the phase variation 1005 for receiver 4F exceeds the threshold deviation 1003. The phase anomaly of receiver 4F was confirmed to be due to physical sensor damage. If any receiver has a reference value outside threshold deviation, the receiver may be flagged for correcting the phase deviation, such as physically inspecting the receiver, repairing the receiver, replacing the receiver, calibrating the receiver, and/or adjusting the signals generated by the receiver as further described herein.

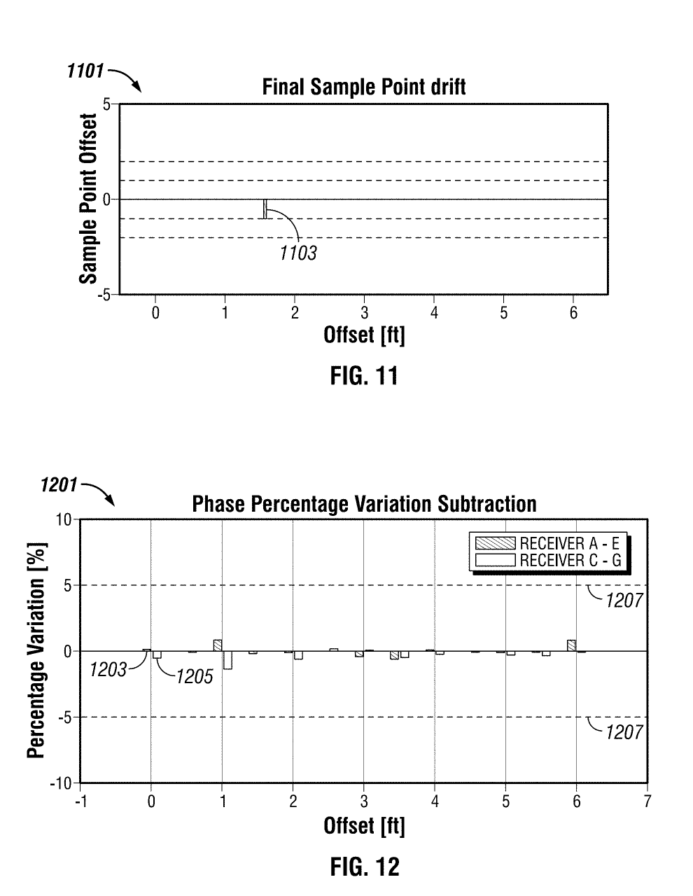

In some situations, the receiver phase error can be the result of a malfunctioning electronic digitizer. Consequently, the arrival time residual can be normalized by the sampling rate of the digitizer to provide another reference value for determining a phase issue. If the arrival time to sampling interval ratio is close to an integer, this may indicate a digitization issue. It should be appreciated that other normalization factors can be used to analyze the phase error of the recorded signal. For example, FIG. 11 shows a graph view of the arrival time residuals 1101 normalized based on the sampling rate of the digitizer, in accordance with one or more embodiments. As shown, the normalized arrival time for receiver 4F is about one times the sampling rate, which may indicate that the digitizer of receiver 4F has an issue.

Modally decomposed signals may be used for various data products. Dipole decomposition can amount to subtraction of the signals recorded by two opposite receivers in a ring and within the plane of the dipole source. For a low-frequency monopole firing, the decomposed signals have a higher tolerance of certain phase problems, but for a high-frequency dipole firing, the same phase error can result in inappropriate decomposed flexural waveforms. Consequently, the phase variations between opposite receivers can be monitored to determine phase correction factors for receivers used in modal decomposition. For example, FIG. 12 shows a graph view of phase variations 1201 to assess modally decomposed dipole signals, in accordance with one or more embodiments. As shown, the phase variations 1203 and 1205 represent the phase variations for modally decomposed signals between receivers A and E and receivers C and G, respectively. The phase variations 1201 may be calculated by calculating a phase variation for the modally decomposed signals of the receiver pairs. Although receiver 4F has a phase problem as previously discussed, receiver 4F is not involved in the orthogonal subtraction for dipole decomposition, and thus, the dipole signals used to calculate the phase variations 1201 are not affected by receiver 4F, and the overall quality of dipole signals are within a selected threshold deviation 1207 of 5%.

The phase variations for a dipole signal can be derived from the phase variations of recorded monopole signals. As the phase variations are based on the same reference signal, by performing the dipole decomposition of the phase variations with monopole signals, the result of decomposed variations are used to represent the dipole phase variations in comparison to an othorgonal pair of decomposed dipole signals. It should be appreciated that a reference value to assess the modal decomposition of receivers can be calculated for any suitable set of receivers and is not limited to a pair of receivers for bi-modal decomposition.

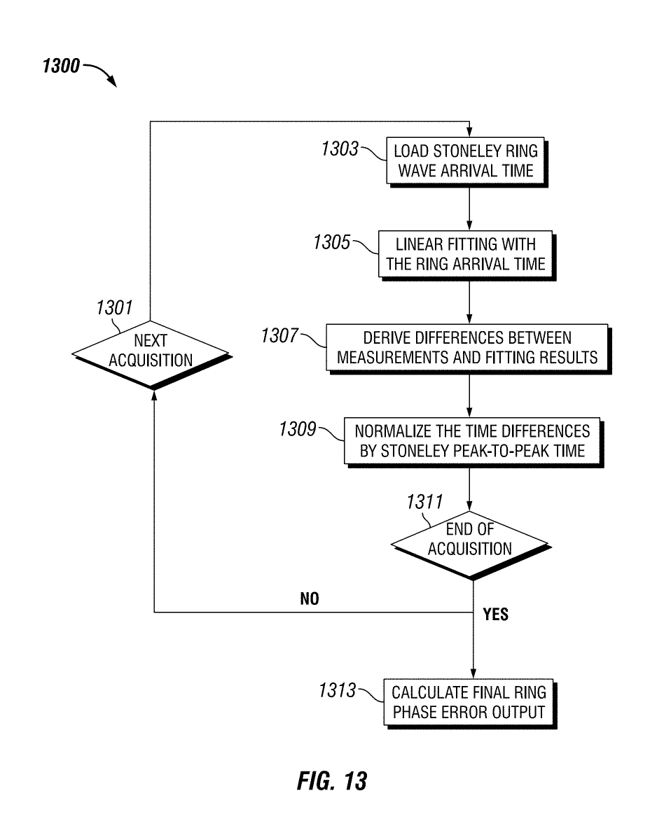

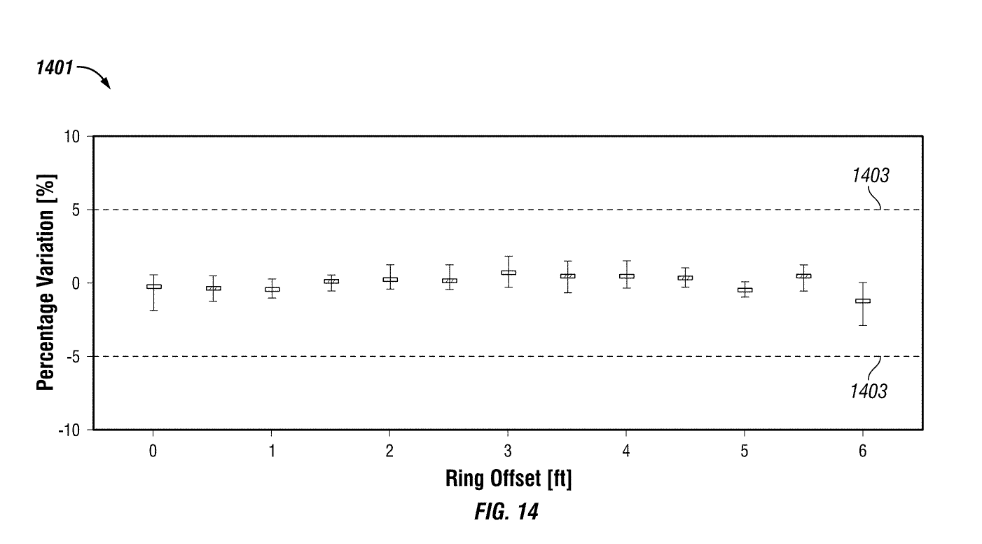

The normalized phase variation can also be applied to assessing phase issues with the receiver ring. For example, FIG. 13 shows a flow chart view of a method 1300 to determine a phase variation for a ring of receivers, in accordance with one or more embodiments. A ring phase variation is useful because the phase variation might be from the ring related electronics, but not from each receiver itself. Acoustic wave data is acquired using an acoustic logging tool at step 1301 as described herein with respect to FIG. 7. The arrival time of each ring is statistically defined as the median value of all receivers' arrival times in that ring at step 1303; however, it should be appreciated that any other suitable reference value can be used to define the arrival time of the ring, such as the mean arrival time of the receivers. A best-fit curve is derived at step 1305, as well as its corresponding misfit at step 1307. With the same concept of normalization for receiver phase variation discussed above, the misfit of ring arrival time is normalized by a normalization factor, such as the Stoneley peak-to-peak time, and used as the ring phase variation. A ring phase correction and variation can be determined by processing multiple acquisitions at steps 1311 and 1313. For example, FIG. 14 shows a graph view of a ring phase variations 1401 calculated from multiple Stoneley wave acquisitions, according to one or more embodiments. The phase variations 1401 are computed from the data fitting results. The phase variations 1401 are within a threshold deviation 1403 of 5%, which may indicate no phase issues due to the ring configuration or electronics. If any ring has a reference value outside the threshold deviation, the ring may be flagged for correcting the phase deviation, such as physically inspecting the ring, repairing the ring, replacing the ring or components of the ring, calibrating the ring, and/or adjusting the signals generated by the ring and/or a receiver as further described herein.

### Receiver Sensitivity Quality Control Workflow

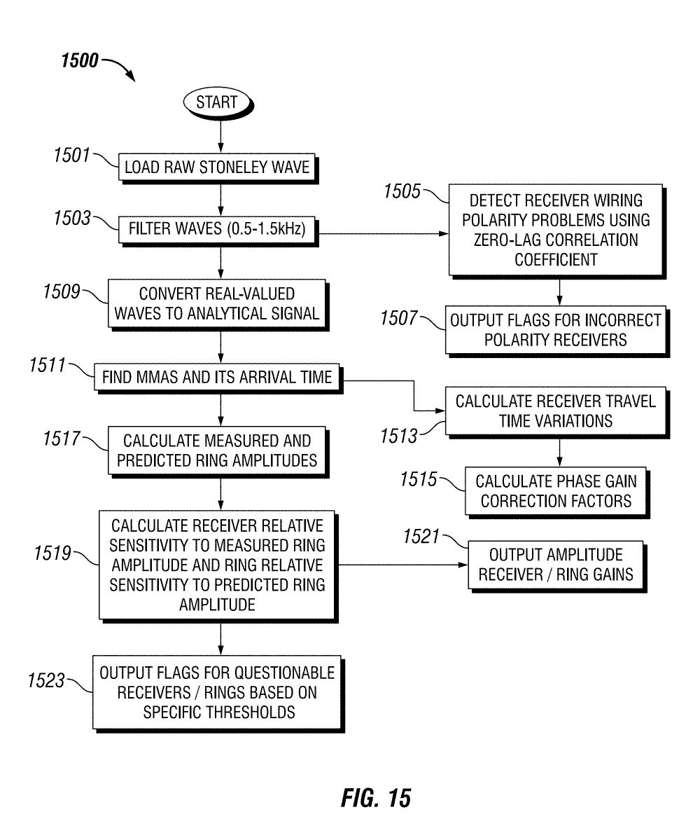

FIG. 15 depicts a flow chart view of a receiver sensitivity quality control process 1500 to monitor and calibrate an acoustic logging tool, such as the logging tool 106 of FIG. 1, according to one or more embodiments. The method 1500 provides the receiver quality control/calibration process for a single acquisition.

At step 1501, a selected depth measurement of the raw Stoneley wave data is loaded into the algorithm process. The depth measurement comprises a collection of signals indicative of a Stoneley wave that originated from an acoustic source firing acoustic waves into a borehole. The acoustic waves travel through the borehole and surrounding formation and are recorded by one or more receivers on the tool. The signals are saved on one or more computers on the tool, transmitted to the surface where they are saved to one or more computers on the surface, and transmitted to a data analysis center where they are saved to one or more computers there. The measurement may be analyzed on any or all computers mentioned above. At step 1503, the recorded Stoneley wave signals are filtered using a band-pass filter (e.g., 0.5 to 1.5 kHz band-pass filter) or any other suitable filter.

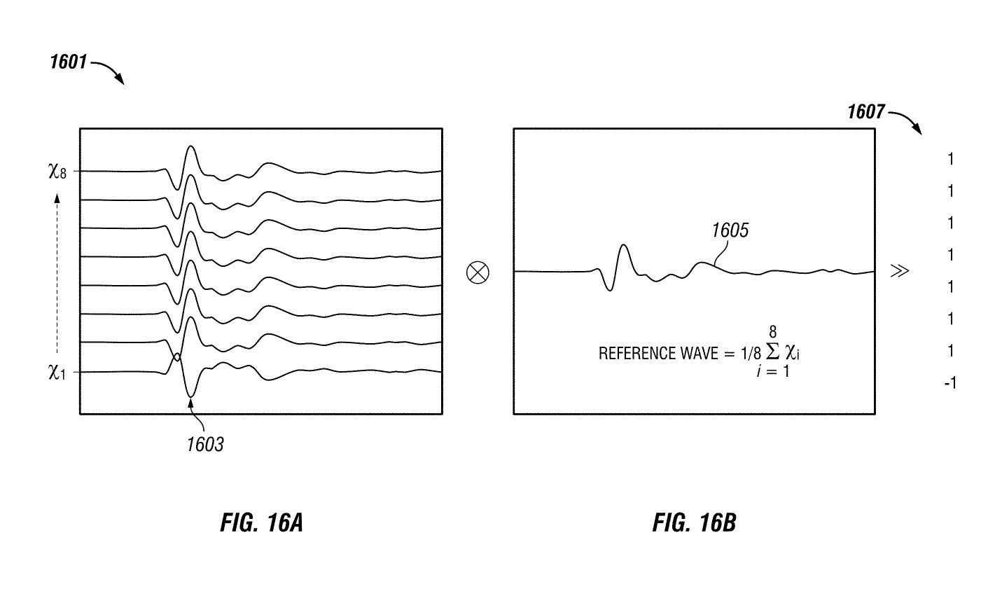

At step 1505, the filtered signals are used to determine if there is a possible issue with wire cross-over for a receiver. A polarity error could occur on installation of a receiver when the wires are connected to the receiver with a reversed polarity. If there is a receiver wire cross-over issue, the resulting recorded signal is inverted. FIG. 16A shows a graph view of recorded signals 1601 by the receivers x₁-x₈, in accordance with one or more embodiments. As shown, the signal 803′s polarity is inverted from the rest of the signals.

To identify the receiver with the polarity error, a reference signal is calculated from the recorded signals, for example, an averaged signal from the receivers in a ring may be calculated as the reference signal. FIG. 16B shows a graph view of a reference signal 1605 calculated to analyze the polarity of a receiver, in accordance with one or more embodiments. A cross-correlation is performed between each signal of the receivers x₁-x₈ and the averaged reference signal 1605. The normalized zero-lag correlation coefficient is checked. At step 1507, if the value of the zero-lag correlation coefficient is 1, the receiver does not have a polarity issue; however, if the value is −1, the output is set to −1 to flag that receiver for a polarity issue, such as the output 1607 shown in FIG. 16B. To correct the polarity issue, the signals generated by the receiver identified with the polarity issue may be inverted.

The use of cross-correlation to identify a receiver with incorrect polarity is based on the assumption that few, if any, of the receivers have polarity issues. For example, for a receiver ring with eight receivers, it may be assumed that only three or less receivers in the ring can be detected as having an incorrect polarity with the cross-correlation method.

At step 1509, the filtered signals are converted to an analytical signal with Hilbert transform using a Fourier transform or FIR filter as described herein. The use of a short length FIR filter allows the method to be implemented as efficient as a Fourier transform method. The MMAS can be derived as an absolute amplitude of the analytical signal. At step 1511, with the derived MMAS, the arrival time of the MMAS is obtained to identify receivers with phase errors.

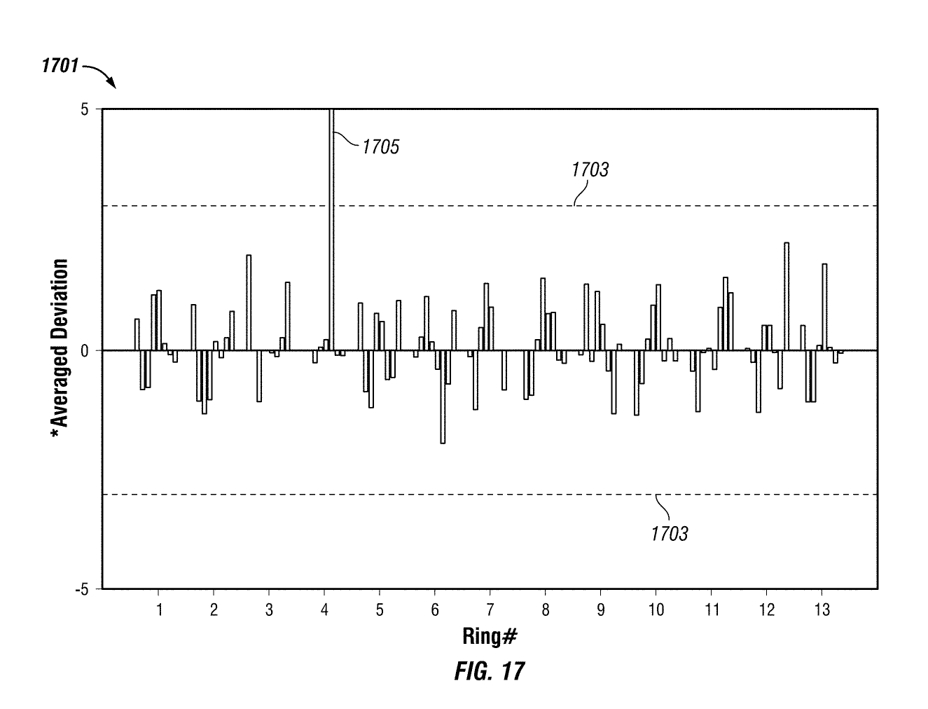

At step 1513, the arrival time variations are calculated as reference values for the receivers. For example, FIG. 17 shows a graph view of arrival time variations 1701 calculated for the receivers, in accordance with one or more embodiments. The variations 1701 are grouped by ring and shown as bars with averaged deviation in the ordinate. The arrival time variations for ring four are calculated from the signals 301 of FIG. 3. As shown in FIG. 17, two dashed horizontal lines 1703 at +3 and −3 times averaged deviation are example threshold deviations of arrival time variation, πᵢ. However, other suitable threshold deviations may be used depending on the level of quality control desired. The arrival time variation 1705 for receiver 4F is shown to be an outlier and indicates a misaligned signal against the rest of signals recorded in the ring and across the tool. The phase misalignment of receiver 4F is also evident by visually comparing the signals 301 shown in FIG. 3.

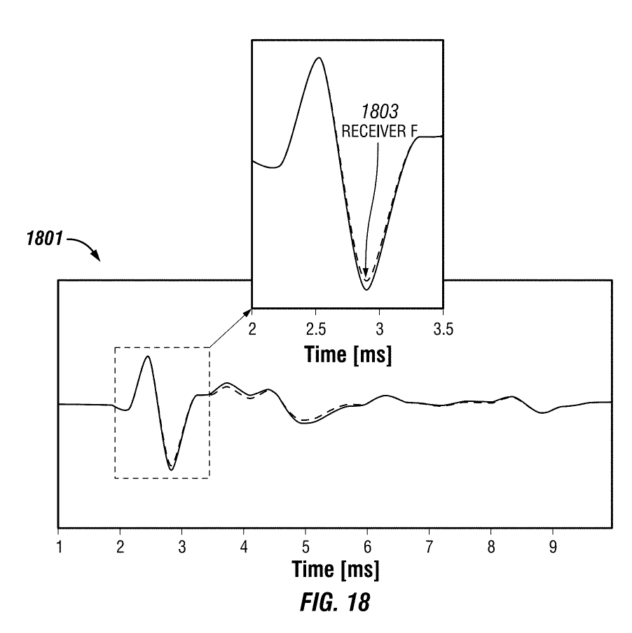

At step 1515, phase correction factors are calculated and output for the signals with phase deviations identified by the comparison between the reference value and the threshold deviation. The phase corrections can be determined and applied in the frequency domain or time domain. In the frequency domain, the phase spectra for the receivers in a ring are used by calculating median values of the phase for each frequency to form a ring phase spectrum, which is used as a reference value to correct the outlier's phase spectrum. The phase differences between the outlier and the median ring phase spectrum are applied. For example, in FIG. 17, receiver 4F′s phase spectrum is corrected to match ring four's median phase spectrum. The frequency domain corrected signal is transformed into the time domain to complete the phase correction process. For example, FIG. 18 shows a graph view of signals 1801 for receiver four after phase correction has been applied to the signals of FIG. 3, in accordance with one or more embodiments. As shown, the dashed curve 1803 depicts the phase corrected signal for receiver F. By visual comparison to the grouped ring four's signals shown in FIG. 3, the signal 1803 for receiver F is aligned properly with the other signals. In the time domain, the signals can be aligned based on the times associated with the MMAS values. The time-domain alignment method is only a first-order correction that assumes the phase shift is linear across all frequencies.

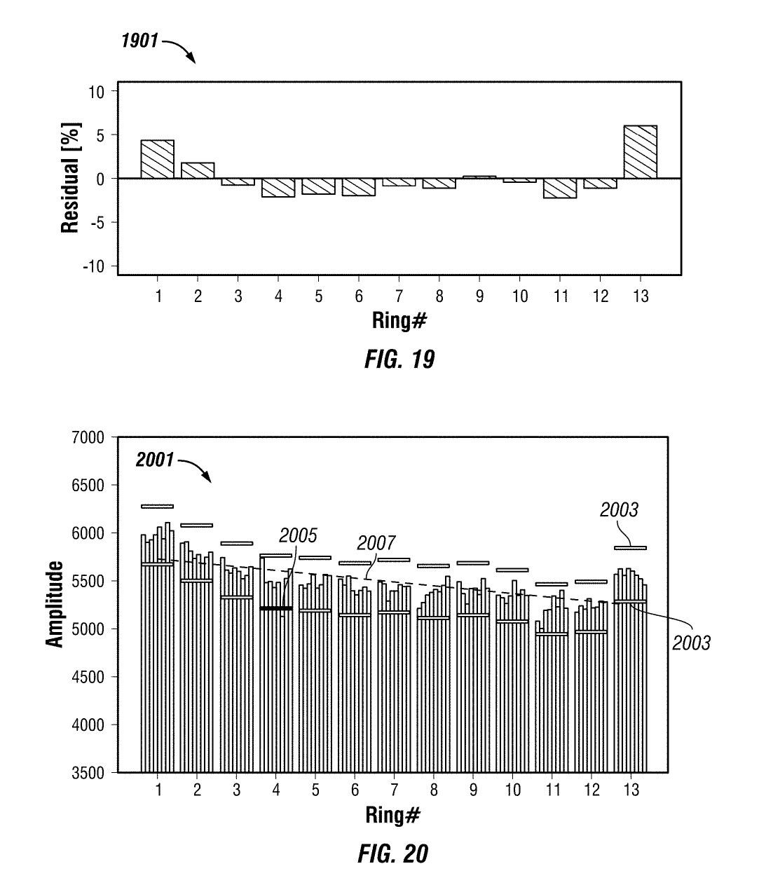

Referring to FIG. 15, at step 1517, with the derived MMAS values, the ring median values across all receivers in separate rings are used as reference amplitudes. These reference amplitudes are further processed to predict ring median amplitudes using exponential curve fitting or any other suitable regression model. The differences between the reference and predicted ring median amplitudes represent the ring sensitivities. For example, FIG. 19 shows a graph view of residual percentage variations 1901 (dAR) for a depth of acquisition, in accordance with one or more embodiments. As shown, each bar corresponds to a ring for the tool. A threshold deviation is set for 10%, and therefore, there are no ring outliers depicted in FIG. 19. For ring amplitude gains, the ratio of measured and predicted ring amplitudes can be applied to correct the ring median to the predicted value.

Referring to FIG. 15, at step 1519, each receiver's amplitude is assessed against the other receivers in the ring using the measured ring median amplitude and each ring amplitude sensitivity is assessed against the predicted ring amplitude as discussed above. FIG. 20 shows a graph view of the receiver amplitude sensitivities 2001 for a depth of acquisition across the tool. As shown, the receiver amplitude sensitivities 2001 are MMAS values of the Stoneley wave grouped by ring based on the ring geometry. Threshold deviations of ±5% from the ring median sensitivities are shown as horizontal bars 2003. However, different threshold deviations may be used depending on the level of quality control desired. The horizontal bar color may be changed for outliers rings with outliers, or any other suitable indication method may be used. In this example, a horizontal bar 2005 is depicted darker than the other bars 2003 to identify an amplitude sensitivity outlier in ring four, such as receiver 4F, which has an amplitude sensitivity lower than the rest of the receivers in ring four.

A function can be determined to fit the measured ring median values using a suitable regression model, such as extrapolation, interpolation, linear regression, polynomial regression, non-linear regression, or the like. An exponential curve 2007 fitting the measured ring median values is shown and represents the predicted ring sensitivity median values, given by:

y=5727.4* exp(−0.015x)

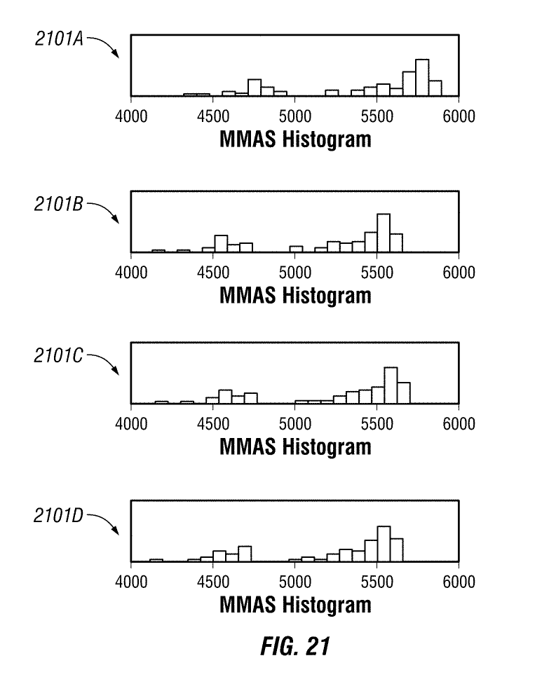

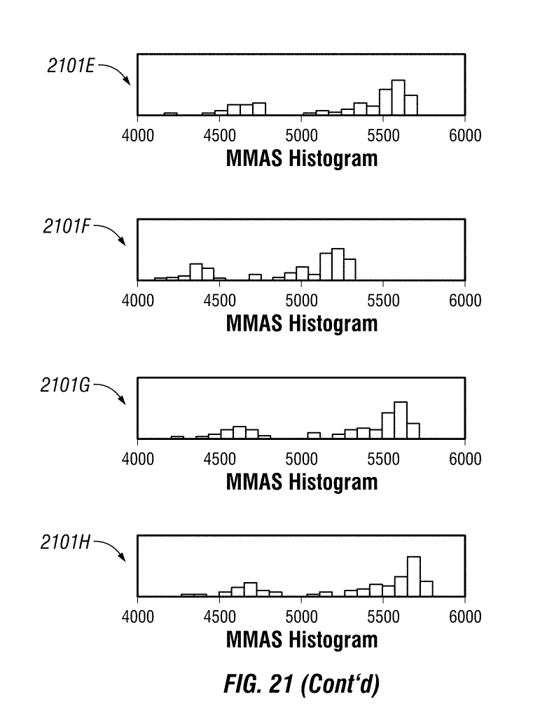

FIG. 21 shows graph views of amplitude histograms 2101A-H for the receivers in ring four, in accordance with one or more embodiments. As shown, each amplitude histogram 2101A-H represents a receiver's amplitude sensitivity distribution from multiple measurements in a cased borehole. Each histogram 2101A-H provides a general understanding about the receiver's median amplitude and median amplitude's distribution range. In general, the histograms 2101A and 2101F are not aligned with the rest of the histograms for the receivers. The histogram 2101A indicates that receiver A′s amplitude is higher relative to the other histograms, whereas the histogram 2101F indicates that receiver F′s amplitude is lower relative to the other histograms. The histograms 2101A and F match the receiver amplitude sensitivities for the single measurement shown in FIG. 20, where the amplitude sensitivity for receiver F is below the threshold deviation, and the amplitude sensitivity for receiver A is still within the threshold deviation but higher than the rest of the receivers in ring four.

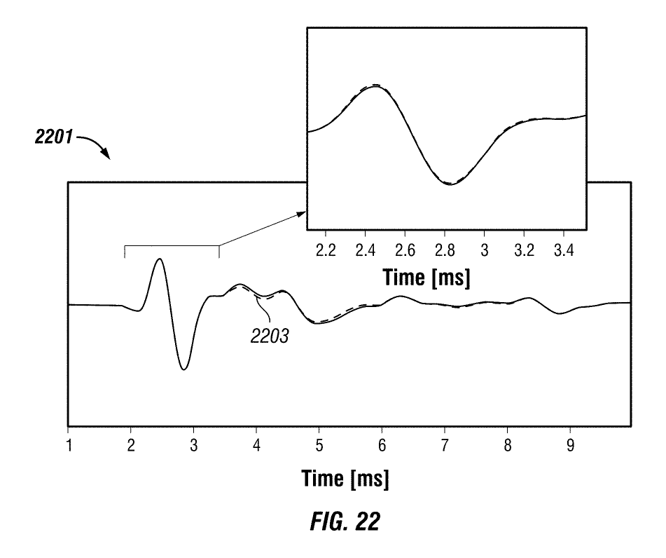

Referring to FIG. 15, at step 1521, amplitude gain corrections (such as receiver 4F in FIGS. 20 and 21) can be calculated, output, and applied to the signals. The correction factors can be obtained from the ratio of the measured receiver amplitudes (A) and the ring median amplitude (AR). A constant gain correction factor can applied to the signal in the time domain. The assumption for applying the constant gain is that the amplitude gain derived from band-pass filtered signal is not frequency dependent, but consistent over the full frequency band. For example, FIG. 22 shows a graph view of amplitude and phase corrected signals 2201, in accordance with one or more embodiments. As shown, based on the phase correction result depicted in FIG. 18, the amplitude of the signal for receiver 4F is corrected as well. The signal for receiver 4F shows a significant improvement in alignment with the rest of signals in regards with phase and amplitude. By comparing the zoom-in windows of FIGS. 3, 18, and 22, the signal 2203 for the receiver F matches better after the amplitude and phase corrections are applied to the signals. At step 1523, the receivers and/or rings exhibiting phase, gain, or polarity issues can be identified and output for physical inspection, repair, replacement, calibration, or further processing, such as adjusting the recorded signals. As used herein, adjusting a signal refers to adjusting a phase and/or an amplitude of the signal.

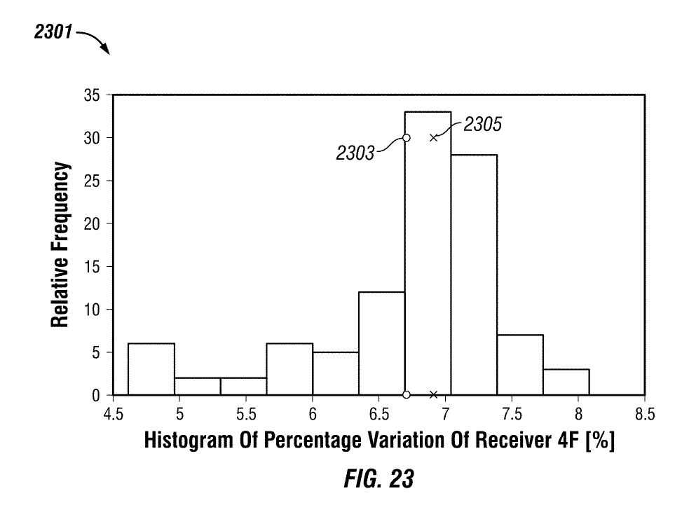

The amplitude correction factors can also be derived from Stoneley wave acquisitions at multiple depths, which can be mean or median values of the amplitude gains for multiple depth data. For example, FIG. 23 shows a graph view of a histogram 2301 of the receiver 4F′s MMAS percentage across 104 acquisitions at different depths, in accordance with one or more embodiments. The percentage variation is related to the receiver gain factor. The mean 2303 and median 2305 values of the percentage variations are very close to each other, and either one can be considered as an amplitude correction factor. However, the median 2305 is preferred as the amplitude correction factor. Note the relative gain increase is about 7% for receiver 4F.

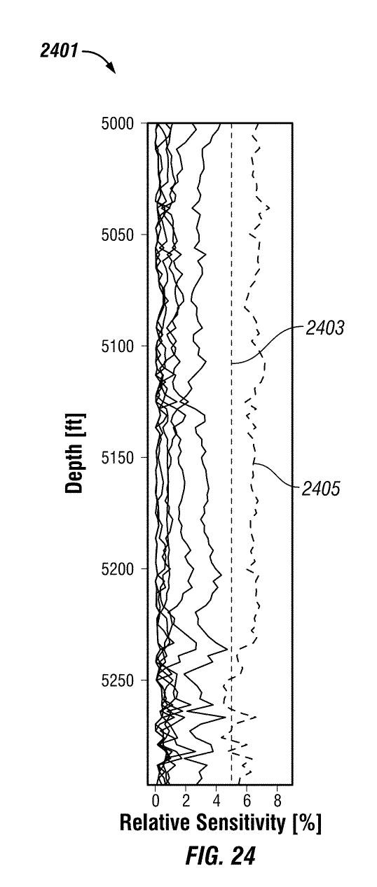

As an alternative to FIG. 20, which demonstrates the receiver quality control for a single acquisition, continuously deriving the quality control outputs over a logging pass enables a log view of receiver sensitivity result. For example, FIG. 24 shows a graph view of the MMAS receiver sensitivity measurements 2401 with respect to depth, in accordance with one or more embodiments. As shown, the receiver sensitivity measurements 2401 are the receiver amplitude percentage variations for ring-four of the tool. A threshold deviation 2403 of 5% chosen based on each single acquisition amplitude sensitivity threshold is used to assess the quality of the amplitude sensitivities 2401. However, different thresholds than 5% may be selected for different embodiments, based on the level of quality control desired. Receiver 4F′s sensitivity 2405 is shown predominantly above the threshold deviation 2403, but at some depths below 5250 feet the sensitivity 2405 for receiver 4F is within the threshold deviation. Thus, FIG. 24 demonstrates that the sensitivities of a receiver depicted across multiple acquisition depths provides improved confidence to locate the problematic receivers.

Given the receiver amplitude, which can be characterized by a single value of MMAS or other implementations, such as RMS amplitude, the receiver amplitude variations in a ring can be interpreted as a relative measure of receiver sensitivity. For example, at a single depth, the 104 amplitude variations of receivers are obtained for the logging tool, and each represents relative receiver status to the ring reference signal. Based on a single depth measurement, multiple depths of quality control results can be derived as a quality control log, to obtain a single converged answer for the final representation of receiver amplitude in the ring. This final quality control product is required to be derived in a logging of a cased hole section using a centralized tool and very low-frequency source pulse. Theory and data analysis confirm that a higher frequency source and non-ideal conditions, such as borehole rugosity, decentralization, and formation heterogeneity, can yield inaccuracies in the measured sensitivities.

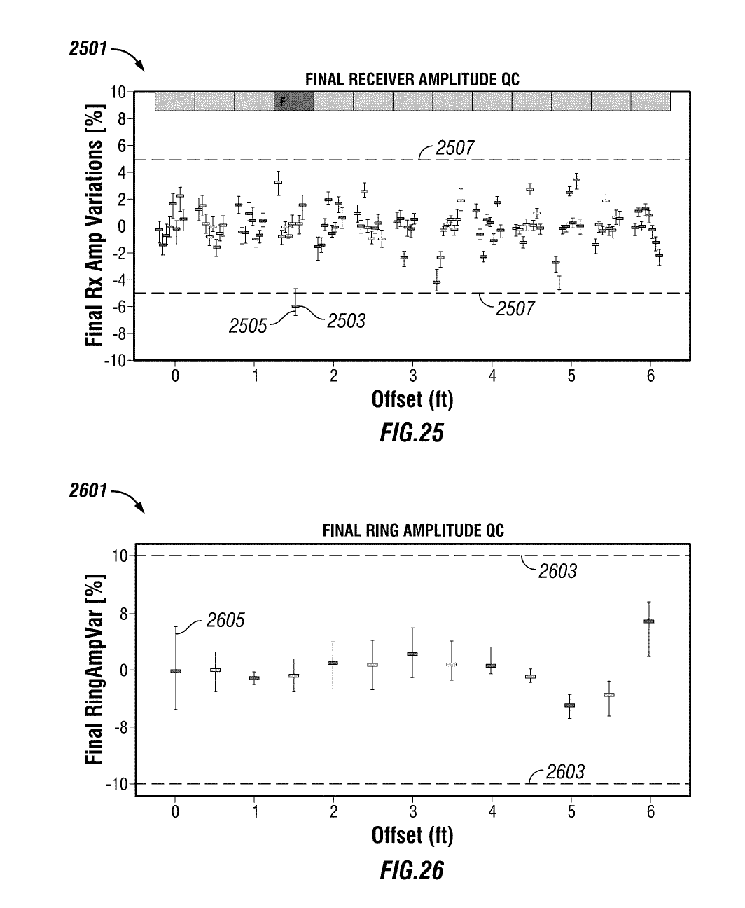

For each single receiver, a final sensitivity variation is calculated from the mean or median value of the sensitivities derived from a depth range in the cased section. For example, based on FIG. 24 receiver amplitude sensitivity log, FIG. 25 shows a final graph view of amplitude sensitivity variations 2501 for the receivers across multiple depth measurements or acquisitions of a tool, according to one or more embodiments. As shown, the amplitude variations 2501 are determined using more than 600 acquisitions of Stoneley wave measurements at different depths along a borehole. However, it should be appreciated that the amplitude variations can be determined from any number of acquisitions of Stoneley wave measurements. FIG. 25 depicts a statistical output based on depth measurements, such as the depth measurement depicted in FIG. 12. Each box 2503 represents the corresponding receiver amplitude sensitivity relative to a ring. An error bar 2505 vertically across the box 2503 represents the measurement uncertainty of the corresponding receiver, which is derived from the empirical probability distribution function of all 600 quality control results. A receiver outlier is defined by crossing a defined threshold deviation. As an example, 5% of amplitude variation from a ring is chosen as a threshold deviation 2507.

Some tools have hardware configurations that make it possible to have sensitivity variations from one ring to the next, which are independent of sensitivity variations from one receiver to the next within the same ring. A ring amplitude variation is calculated from the residuals of measured and predicted ring amplitude. A similar approach is applied to collect multiple acquisitions and derive final ring amplitude sensitivities based on a range of depths in a cased hole section. For example, FIG. 26 shows a graph view of the ring amplitude variations 2601 calculated from multiple depth measurements, in accordance with one or more embodiments. As shown, a threshold deviation 2603 is set at 10% from the predicted ring median amplitude variation, and the uncertainty 2605 for a ring is shown as a vertical bar across each of the ring amplitude variations 2601.

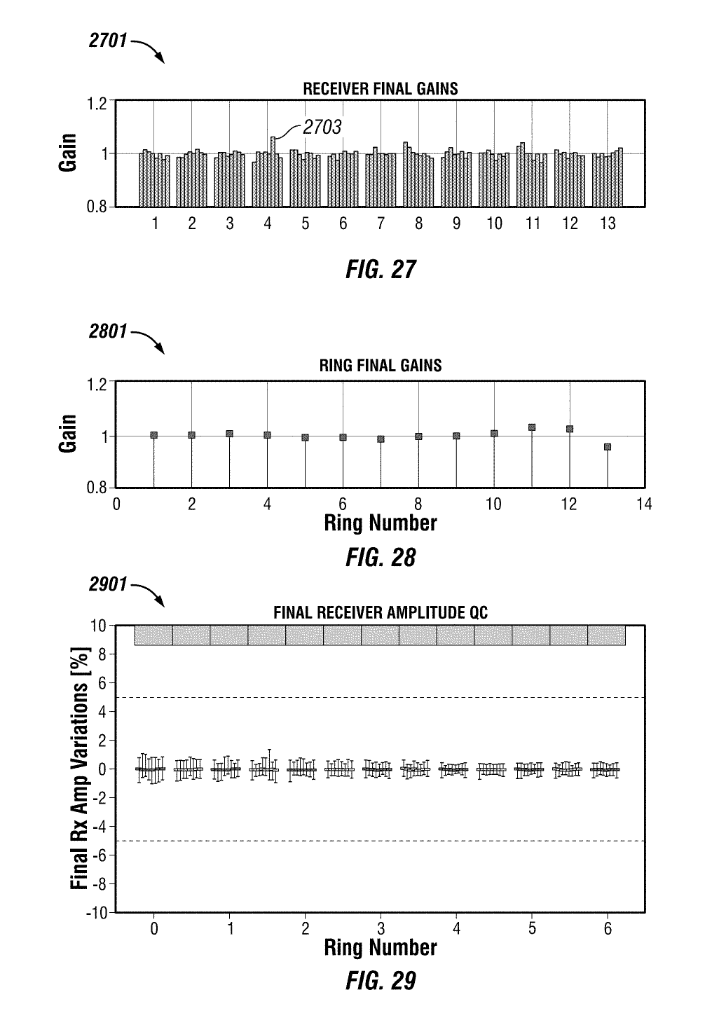

Correcting amplitude variations is a critically important step before the recorded signals of the Stoneley wave are used in modal decomposition (e.g., bi-modal analysis) or other advanced data products such as measuring permeability from Stoneley wave attenuation. The receiver and ring amplitude variations can be used to compute amplitude correction factors, which are calibration factors that, when multiplied to the receivers' time series amplitudes, correct the amplitudes for variations in receivers' response functions. FIG. 27 shows a graph view of amplitude correction factors 2701 computed from the receiver amplitude variations of FIG. 25. FIG. 28 shows a graph view of amplitude correction factors 2801 computed from the ring amplitude variations of FIG. 26, in accordance with one or more embodiments.

As shown in FIG. 27, the amplitude correction factors 2701 are grouped by ring number based on ring geometry similar to FIG. 20. It is apparent that receiver 4F 2703 requires the largest amplitude correction factor relative to the other receivers. FIG. 29 shows a graph view of corrected amplitude sensitivities 2901 for the receivers, in accordance with one or more embodiments. As shown in FIG. 29, the amplitude correction factors of FIG. 27 are used to correct the receiver amplitudes, resulting in small amplitude variations and uncertainties that are almost zero.

As previously discussed, for a low-frequency or high-frequency monopole firing, a modal decomposition is based on an average of receiver signals in a ring, whereas for dipole firing, a weighted average can be employed. The modal decomposition for a dipole can amount to subtraction of the signals recorded by two opposite receivers in a ring and within the plane of the dipole source. In this subtraction operation, the resulting bi-modal signal can amplify (by at most a factor of 2) sensitivity differences as compared to the resulting signal from monopole decomposition. Therefore, a method to quantify and compare the subtraction result with the monopole amplitude quality control results can be used to study the effect of an imbalance that is slightly less than the maximum permitted amplitude threshold on a pair of opposite receivers.

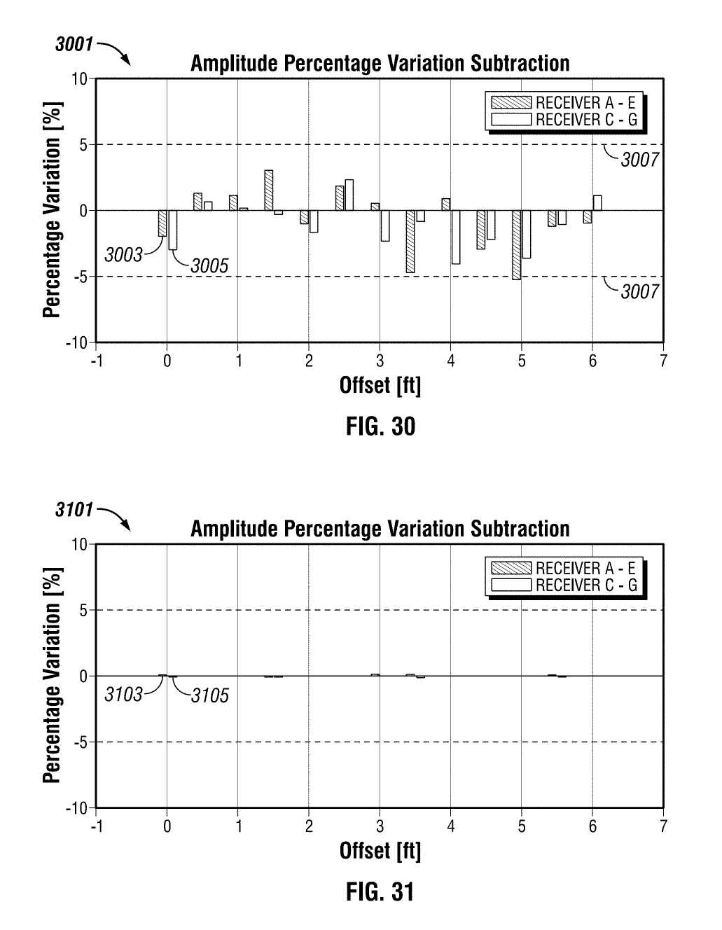

FIG. 30 shows a graph view of amplitude variations 3001 for receivers to assess modally decomposed signals, in accordance with one or more embodiments. The modal decomposition may apply a dipole decomposition taking the difference between the amplitudes of opposing receivers. The receiver variations 3003 and 3005 represent the modally decomposed variations between receivers A and E and receivers C and G, respectively, for the acoustic logging tool. The amplitude variations 3001 may be calculated by modally decomposing the reference values for the receiver pairs. The amplitude variations 3001 may be a modally decomposed reference value for a set of receivers. Gain corrections can be created for the dipole signals from either the monopole or the dipole analyses. As shown in FIG. 30, amplitude variation 3003 for the receiver AE pair shows an amplitude mismatch of about 3%, but still within the 5% threshold deviation 3007. The outlier receiver 4F is not used for dipole decomposition because the receiver 4F is not within the dipole transmitter plane, so the receiver 4F′s sensitivity issues do not introduce any signal degradation to the dipole signals, assuming a subtraction approach is used for bi-modal decomposition. However, if the −6% receiver 4F sensitivity variation was encountered on one of the in-plane receivers (such as 4E, which has +3% amplitude sensitivity variation as shown in FIG. 25), the resulting dipole decomposition would yield a signal with an amplitude variation of 9%, which is derived from 3%-(−6%), exceeding the threshold deviation 3007 in this example.

FIG. 31 shows a graph view of amplitude sensitivities 3101 for amplitude corrected signals before dipole decomposition, according to one or more embodiments. As shown, the amplitude sensitivities 3103 and 3105 represent the sensitivities for modally decomposed receiver pairs AE and CG, respectively. The amplitude sensitivities 3101 are minimized by applying the amplitude correction factors before dipole decomposition. It should be appreciated that the monopole and dipole analyses are mathematically equivalent, however, the monopole result can be more stable because the reference value for each ring is based on eight receivers rather than two, which is why the dipole results show different sensitivities compared to the monopole analysis (FIGS. 25 and 26).

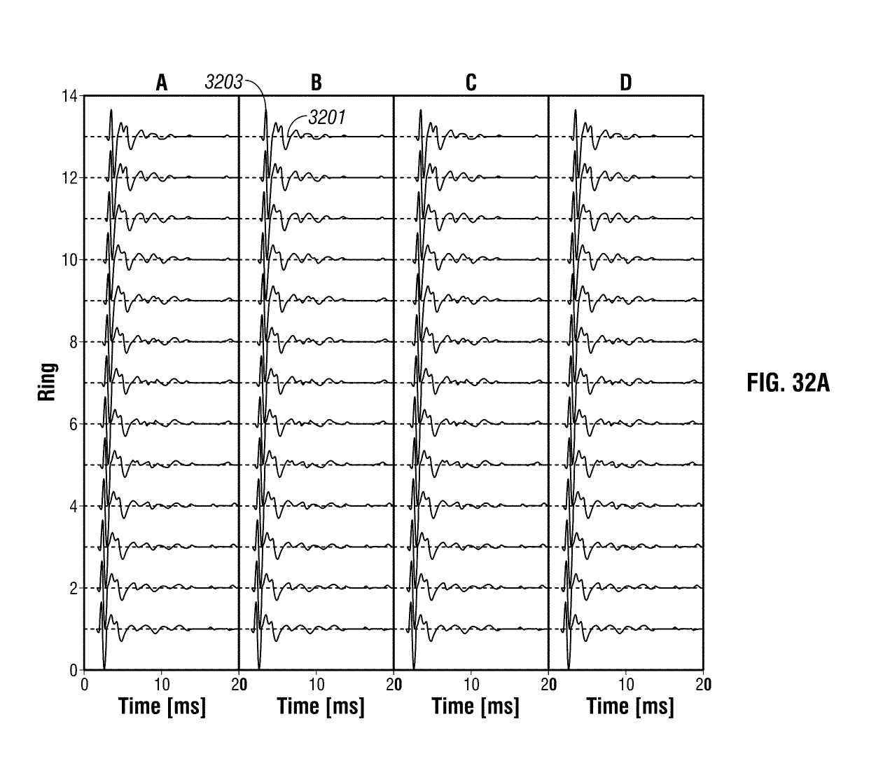

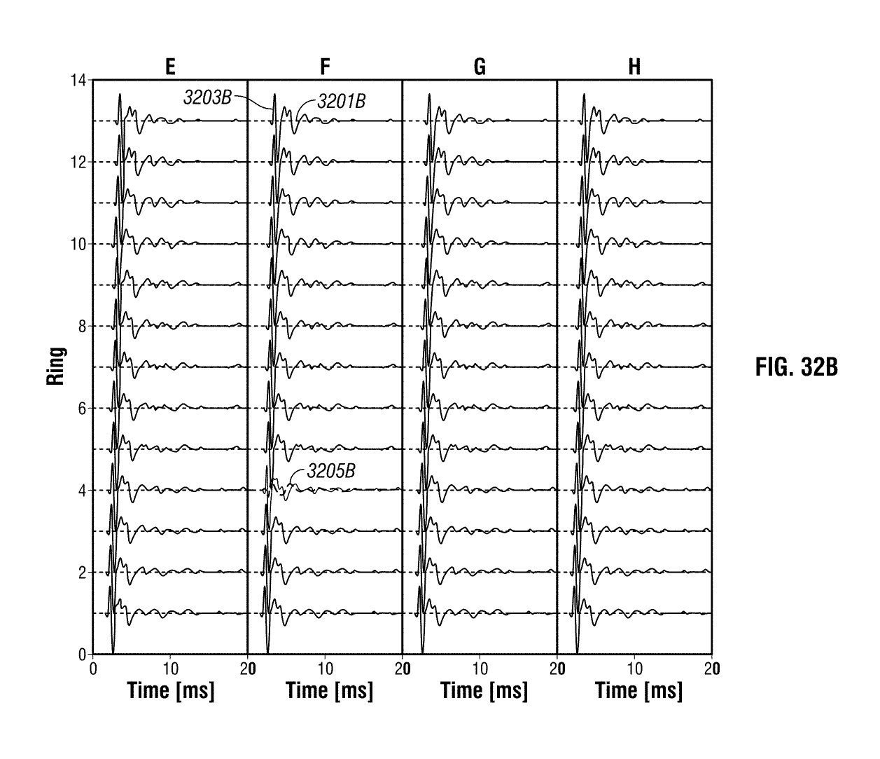

Amplitude sensitivities of the signals may also be assessed in the time domain by comparing waveforms acquired across the tool. For example, FIGS. 32A and B show graph views of residual signals 3201 and recorded signals 3203, in accordance with one or more embodiments. As shown in FIGS. 32A and B, each row represents a ring and each column represents a receiver, depicting 104 individual waveforms. A method of modal decomposition is applied to the recorded signals 3203 for the Stoneley waves to derive the residual signals 3201. Each receiver's recorded signal 3203 for the Stoneley wave is subtracted from a decomposed Stoneley wave, which may include the median of the signals for the receivers in a ring, to derive the residual signals 3201. After subtraction, most of the residuals 3201 are weak indicating a similarity to the decomposed signal, but the residual 3205B of FIG. 32B for receiver 4F has a high amplitude and is identified as an outlier. FIG. 32B shows the residuals 3201B, the recorded signals 3203B, and the high amplitude residual 3205B for the receiver F.

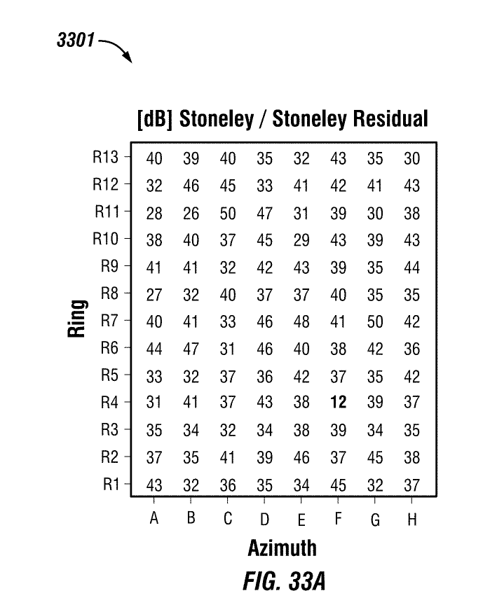

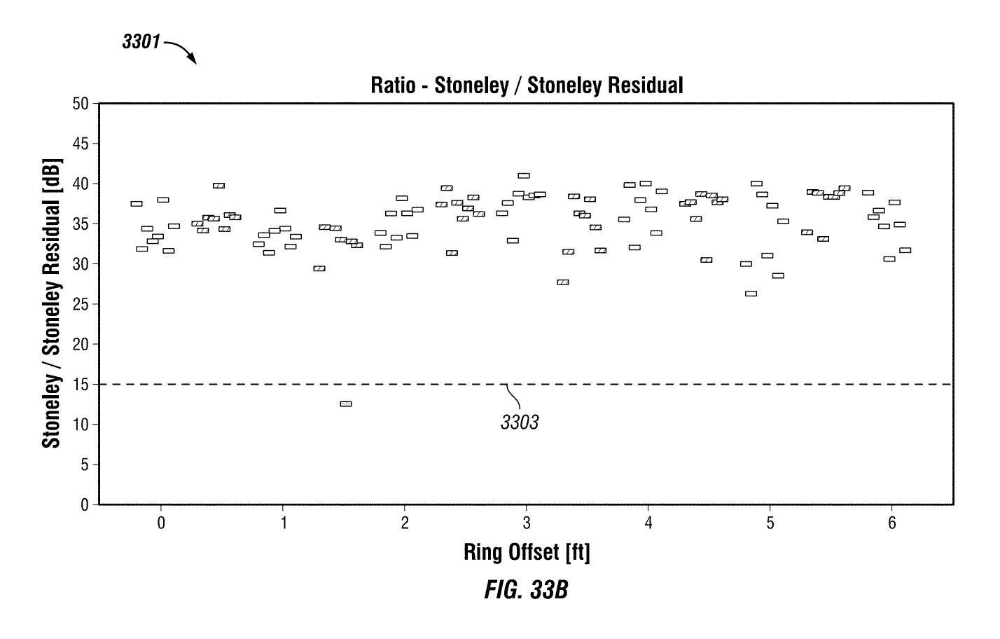

The signals can also be quantified by measuring the maximum amplitude or energy of waves before and after subtraction. For example, FIG. 33A shows a chart view of ratios of the Stoneley waves and the Stoneley wave residuals converted to decibel values 3301, and FIG. 33B shows a graph view of the decibel values 3301, in accordance with one or more embodiments. As shown in FIG. 33B, a threshold deviation 3303 of 15 dB is selected to detect problematic receivers.

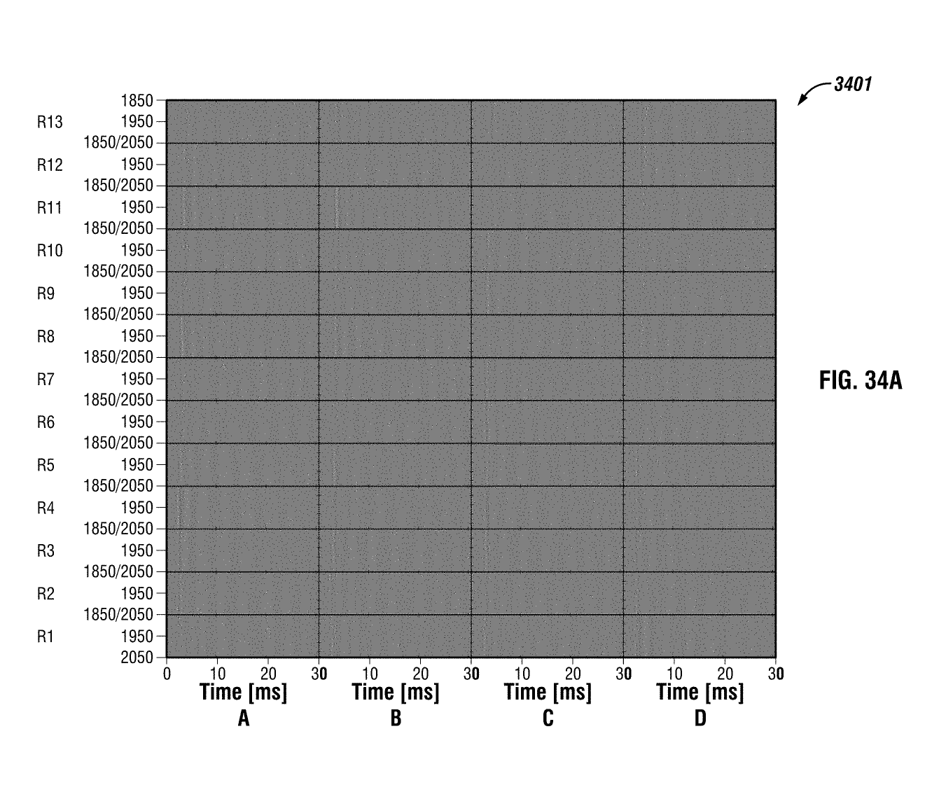

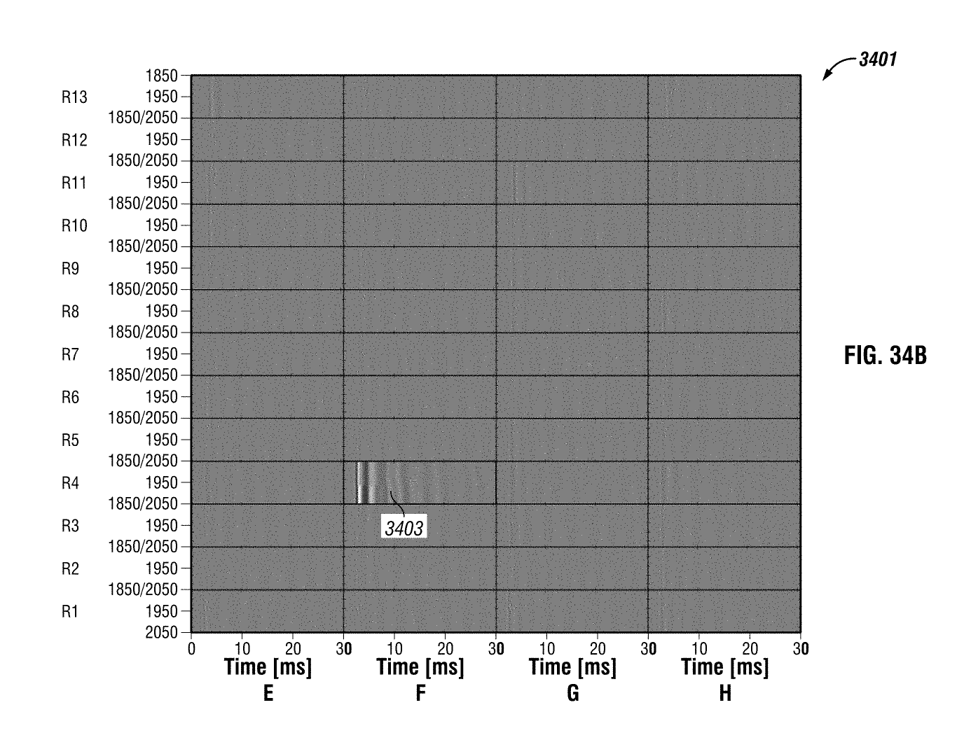

FIGS. 34A and B show graph views of a log-based quality control display for the residual Stoneley waves 3401, in accordance with one or more embodiments. As shown, each row of cells represents a ring and each column of cells represents a receiver. The Stoneley wave residual for each receiver is shown as a variable density log (VDL) across multiple depth measurements as a function of time. Each cell depicts a contour plot of the Stoneley wave residuals 3401 over a depth of measurements as a function of time. The y-axis in each cell represents depths or acquisition numbers of the received signals, and the x-axis represents time. Negative amplitudes are white, amplitudes near zero are gray, and positive amplitudes are black. A suitable scaling can be determined to provide a color map range to indicate outliers. For example, a high amplitude Stoneley wave residual 3403 on receiver 4F can be identified, which is consistent with the other amplitude and/or phase sensitivities described herein.

In addition to the embodiments described above, many examples of specific combinations are within the scope of the disclosure, some of which are detailed below:
Example 1: A method of performing quality control for a downhole tool, the method comprising:
   generating a Stoneley wave using an acoustic source;
   generating signals indicative of the Stoneley wave with receivers;
   calculating a reference value from the signals, wherein the reference value is for one of a selected receiver or a selected receiver ring;
   comparing the reference value to a threshold deviation to determine if the reference value is outside of the threshold deviation; and
   if the reference value is outside of the threshold deviation, correcting the deviation for one of the selected receiver or the selected receiver ring.
Example 2: The method of example 1, wherein:
   the reference value for the selected receiver comprises a percent variation of a residual value of a parameter of the signal generated by the selected receiver and a median parameter of the signals from a receiver ring; and
   the reference value for the selected receiver ring comprises a ring percent variation of a ring residual value of a median parameter of the selected receiver ring and a predicted receiver ring variation.
Example 3: The method of example 2, wherein the parameter of the signal comprises at least one of an arrival time of the Stoneley wave for the selected receiver to determine a phase variation, a maximum instantaneous amplitude of the signal for the selected receiver, and a root-mean-square amplitude of the signal for the selected receiver.
Example 4: The method of example 1, further comprising:
   calculating an additional reference value for a set of selected receivers to assess a modal decomposition of the selected receivers in the set;
   comparing the additional reference value to an additional threshold deviation to determine if the additional reference value is outside of the additional threshold deviation; and
   if the additional reference value is outside of the additional threshold deviation, correcting the deviation for at least one of the selected receivers in the set.
Example 5: The method of example 1, wherein the reference value for the selected receiver includes a normalized residual value of an arrival time for the selected receiver and a median arrival time for a receiver ring.
Example 6: The method of example 1, wherein correcting the deviation includes at least one of physically inspecting a device, replacing the device, repairing the device, calibrating the device, adjusting the signal of the selected receiver, and adjusting the signals of the selected receiver ring, wherein the device is one of the selected receiver or the selected receiver ring.
Example 7: The method of example 6, wherein adjusting the signal comprises adjusting at least one of the phase and amplitude of the signal.
Example 8: The method of example 1, further comprising:
   calculating additional reference values from the signals for more than one receiver ring;
   determining a function for the additional reference values based on a regression model; and
   comparing the additional reference values to the function.
Example 9: The method of example 1, further comprising:
   calculating an averaged signal from the signals of a receiver ring;
   comparing the signal of the selected receiver to the averaged signal to identify a polarity issue with the selected receiver; and
   inverting the signal of the selected receiver if the polarity issue is identified.
Example 10: The method of example 1, further comprising:
   generating the Stoneley wave at different locations in a borehole using the acoustic source;
   generating additional signals indicative of the Stoneley wave with the receivers at the different locations in the borehole;
   calculating a second reference value from the additional signals, wherein the second reference value is for one of the selected receiver or the selected receiver ring;
   comparing the second reference value to a second threshold deviation to determine if the second reference value is outside of the second threshold deviation; and
   if the second reference value is outside of the second threshold deviation, correcting the deviation for one of the selected receiver or the receiver ring.
Example 11: A system for logging a borehole, the system comprising:
   an acoustic source operable to generate a Stoneley wave; and
   acoustic receivers locatable in the borehole and operable to generate signals indicative of the Stoneley wave; and
   a processor operable to:
      calculate a reference value from the signals generated with the acoustic receivers, wherein the reference value is for one of a selected receiver or a selected receiver ring;
      compare the reference value to a threshold deviation to determine if the reference value is outside of the threshold deviation; and
      if the reference value is outside of the threshold deviation, identify one of the selected receiver or the selected receiver ring to correct the deviation.
Example 12: The system of example 11, wherein:
   the reference value for the selected receiver comprises a percent variation of a residual value of a parameter of the signal generated by the selected receiver and a median parameter of the signals from a receiver ring; and
   the reference value for the selected receiver ring comprises a ring percent variation of a ring residual value of a median parameter of the selected receiver ring and a predicted receiver ring variation.
Example 13: The system of example 11, wherein the parameter of the signal comprises at least one of an arrival time of the Stoneley wave for the selected receiver to determine a phase variation, a maximum instantaneous amplitude of the signal for the selected receiver, and a root-mean-square amplitude of the signal for the selected receiver.
Example 14: The system of example 11, wherein the reference value for the selected receiver includes a normalized residual value of an arrival time for the selected receiver and a median arrival time for a receiver ring.
Example 15: The system of example 11, wherein the processor is further operable to correct the deviation by adjusting one of the signal of the selected receiver or the signals of the selected receiver ring.
Example 16: The system of example 11, wherein the processor is further operable to:
   calculate an additional reference value for a set of selected receivers to assess a modal decomposition of the selected receivers in the set;
   compare the additional reference value to an additional threshold deviation to determine if the additional reference value is outside of the additional threshold deviation; and
   if the additional reference value is outside of the additional threshold deviation, identify at least one of the selected receivers in the set to correct the deviation.
Example 17: The system of example 16, wherein the processor is further operable to:
   calculate additional reference values from the signals for more than one receiver ring;
   determine a function for the additional reference values based on a regression model; and
   compare the additional reference values to the function.
Example 18: The system of example 16, wherein the processor is further operable to:
   calculate an averaged signal using the signals of a receiver ring;
   compare the signal of the selected receiver to the averaged signal to identify a polarity issue with the selected receiver; and
   invert the signal of the selected receiver if the polarity issue is identified.
Example 19: A system for logging a borehole, comprising:
   a downhole tool comprising:
      an acoustic source operable to generate a Stoneley wave; and
      acoustic receiver rings, each ring comprising azimuthally-spaced receivers, each
         receiver operable to generate a signal indicative of the Stoneley wave; and a processor operable to:
      calculate a reference value from the signals generated with the receivers, wherein the reference value is for one of a selected receiver or a selected receiver ring;
      compare the reference value to a threshold deviation to determine if the reference value is outside of the threshold deviation; and
      if the reference value is outside of the threshold deviation, identify one of the selected receiver or the selected receiver ring to correct the deviation.
Example 20: The system of example 19, wherein:
   the reference value for the selected receiver comprises a percent variation of a residual value of a parameter of the signal generated by the selected receiver and a median parameter of the signals from a receiver ring; and
   the reference value for the selected receiver ring comprises a ring percent variation of a ring residual value of a median parameter of the selected receiver ring and a predicted receiver ring variation.

This discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

Certain terms are used throughout the description and claims to refer to particular features or components. As one skilled in the art will appreciate, different persons may refer to the same feature or component by different names. This document does not intend to distinguish between components or features that differ in name but not function, unless specifically stated. In the discussion and in the claims, the terms “including” and “comprising” are used in an open-ended fashion, and thus should be interpreted to mean “including, but not limited to . . . .” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. The use of “top,” “bottom,” “above,” “below,” and variations of these terms is made for convenience, but does not require any particular orientation of the components.

Reference throughout this specification to “one embodiment,” “an embodiment,” or similar language means that a particular feature, structure, or characteristic described in connection with the embodiment may be included in at least one embodiment of the present disclosure. Thus, appearances of the phrases “in one embodiment,” “in an embodiment,” and similar language throughout this specification may, but do not necessarily, all refer to the same embodiment.

Although the present invention has been described with respect to specific details, it is not intended that such details should be regarded as limitations on the scope of the invention, except to the extent that they are included in the accompanying claims.

What is claimed is:

1. A method of performing quality control for a downhole tool, the method comprising:
generating a Stoneley wave using an acoustic source;
generating signals indicative of the Stoneley wave with receivers;
calculating a reference value from the signals, wherein the reference value is for one of a selected receiver or a selected receiver ring;
comparing the reference value to a threshold deviation to determine if the reference value is outside of the threshold deviation; and
if the reference value is outside of the threshold deviation, correcting the deviation for one of the selected receiver or the selected receiver ring.

2. The method of claim 1, wherein:
the reference value for the selected receiver comprises a percent variation of a residual value of a parameter of the signal generated by the selected receiver and a median parameter of the signals from a receiver ring; and
the reference value for the selected receiver ring comprises a ring percent variation of a ring residual value of a median parameter of the selected receiver ring and a predicted receiver ring variation.

3. The method of claim 2, wherein the parameter of the signal comprises at least one of an arrival time of the Stoneley wave for the selected receiver to determine a phase variation, a maximum instantaneous amplitude of the signal for the selected receiver, and a root-mean-square amplitude of the signal for the selected receiver.

4. The method of claim 1, further comprising:
calculating an additional reference value for a set of selected receivers to assess a modal decomposition of the selected receivers in the set;
comparing the additional reference value to an additional threshold deviation to determine if the additional reference value is outside of the additional threshold deviation; and
if the additional reference value is outside of the additional threshold deviation, correcting the deviation for at least one of the selected receivers in the set.

5. The method of claim 1, wherein the reference value for the selected receiver includes a normalized residual value of an arrival time for the selected receiver and a median arrival time for a receiver ring.

6. The method of claim 1, wherein correcting the deviation includes at least one of physically inspecting a device, replacing the device, repairing the device, calibrating the device, adjusting the signal of the selected receiver, and adjusting the signals of the selected receiver ring, wherein the device is one of the selected receiver or the selected receiver ring.

7. The method of claim 6, wherein adjusting the signal comprises adjusting at least one of the phase and amplitude of the signal.

8. The method of claim 1, further comprising:
calculating additional reference values from the signals for more than one receiver ring;
determining a function for the additional reference values based on a regression model; and
comparing the additional reference values to the function.

9. The method of claim 1, further comprising:
calculating an averaged signal from the signals of a receiver ring;
comparing the signal of the selected receiver to the averaged signal to identify a polarity issue with the selected receiver; and
inverting the signal of the selected receiver if the polarity issue is identified.

10. The method of claim 1, further comprising:
generating the Stoneley wave at different locations in a borehole using the acoustic source;
generating additional signals indicative of the Stoneley wave with the receivers at the different locations in the borehole;
calculating a second reference value from the additional signals, wherein the second reference value is for one of the selected receiver or the selected receiver ring;
comparing the second reference value to a second threshold deviation to determine if the second reference value is outside of the second threshold deviation; and
if the second reference value is outside of the second threshold deviation, correcting the deviation for one of the selected receiver or the receiver ring.

11. A system for logging a borehole, the system comprising:
an acoustic source operable to generate a Stoneley wave; and
acoustic receivers locatable in the borehole and operable to generate signals indicative of the Stoneley wave; and
a processor operable to:
calculate a reference value from the signals generated with the acoustic receivers, wherein the reference value is for one of a selected receiver or a selected receiver ring;
compare the reference value to a threshold deviation to determine if the reference value is outside of the threshold deviation; and
if the reference value is outside of the threshold deviation, identify one of the selected receiver or the selected receiver ring to correct the deviation.

12. The system of claim 11, wherein:
the reference value for the selected receiver comprises a percent variation of a residual value of a parameter of the signal generated by the selected receiver and a median parameter of the signals from a receiver ring; and
the reference value for the selected receiver ring comprises a ring percent variation of a ring residual value of a median parameter of the selected receiver ring and a predicted receiver ring variation.

13. The system of claim 11, wherein the parameter of the signal comprises at least one of an arrival time of the Stoneley wave for the selected receiver to determine a phase variation, a maximum instantaneous amplitude of the signal for the selected receiver, and a root-mean-square amplitude of the signal for the selected receiver.

14. The system of claim 11, wherein the reference value for the selected receiver includes a normalized residual value of an arrival time for the selected receiver and a median arrival time for a receiver ring.

15. The system of claim 11, wherein the processor is further operable to correct the deviation by adjusting one of the signal of the selected receiver or the signals of the selected receiver ring.

16. The system of claim 11, wherein the processor is further operable to:
calculate an additional reference value for a set of selected receivers to assess a modal decomposition of the selected receivers in the set;
compare the additional reference value to an additional threshold deviation to determine if the additional reference value is outside of the additional threshold deviation; and
if the additional reference value is outside of the additional threshold deviation, identify at least one of the selected receivers in the set to correct the deviation.

17. The system of claim 16, wherein the processor is further operable to:
calculate additional reference values from the signals for more than one receiver ring;
determine a function for the additional reference values based on a regression model; and
compare the additional reference values to the function.

18. The system of claim 16, wherein the processor is further operable to:
calculate an averaged signal using the signals of a receiver ring;
compare the signal of the selected receiver to the averaged signal to identify a polarity issue with the selected receiver; and
invert the signal of the selected receiver if the polarity issue is identified.

19. A system for logging a borehole, comprising:
a downhole tool comprising:
an acoustic source operable to generate a Stoneley wave; and
acoustic receiver rings, each ring comprising azimuthally-spaced receivers, each receiver operable to generate a signal indicative of the Stoneley wave; and
a processor operable to:
calculate a reference value from the signals generated with the receivers, wherein the reference value is for one of a selected receiver or a selected receiver ring;
compare the reference value to a threshold deviation to determine if the reference value is outside of the threshold deviation; and
if the reference value is outside of the threshold deviation, identify one of the selected receiver or the selected receiver ring to correct the deviation.

20. The system of claim 19, wherein:
the reference value for the selected receiver comprises a percent variation of a residual value of a parameter of the signal generated by the selected receiver and a median parameter of the signals from a receiver ring; and
the reference value for the selected receiver ring comprises a ring percent variation of a ring residual value of a median parameter of the selected receiver ring and a predicted receiver ring variation.
